(19) United States
(12) Patent Application Publication
(10) Pub. No.: US 2012/0328187 A1
(43) Pub. Date: Dec. 27, 2012

(54) Text analysis and visualization

(75) Inventor: Stanko Gligorije Vuleta, Ottawa (CA)

(73) Assignee: Mr. Stanko Gligorije Vuleta, Ottawa (CA)

(21) Appl. No.: 13/531,487

(22) Filed: Jun. 22, 2012

Related U.S. Application Data
(60) Provisional application No. 61/500,289, filed on Jun. 23, 2011.

(51) Int. Cl. G06K 9/34

(52) U.S. Cl. 382/164

(57) ABSTRACT

The present invention is a method and system for providing a user with an interface for viewing patent data. In one aspect, certain terms in the patent text are automatically underlined with lines of different types. Each term has an associated line type. User can remove or change underlines. In still another aspect, favicons showing the last three digits of the patent number are used to easily identify which tab corresponds to which patent. In yet another aspect, patent figures are displayed with normal orientation or rotated clockwise. In yet another aspect, an interface is provided for opening multiple patents at the same time.

### CROSS-REFERENCE TO RELATED APPLICATIONS

This application claims the priority filing benefit of U.S. provisional Patent application No. 61/500,289 filed Jun. 23, 2011, incorporated herein by reference in its entirety.

### TECHNICAL FIELD

The present invention relates generally to a system and method for analyzing and viewing text and image data, and more specifically, for analyzing and viewing patent data.

### BACKGROUND

Trying to read and understand a patent can be a tedious job. Patents are written in a legal jargon sometimes referred to as “patentese”. Patentese was developed to minimize ambiguities and differences in patent interpretation. Even the high priests of the black art of patentese, like patent examiners, patent agents and patent lawyers, have trouble reading and understanding patents.

Claims are the most important part of a patent and they are also the most difficult to grasp. Claims are written in one long sentence and they make heavy use of repetitions. After a term is introduced, it is referred to in the same or a similar form in the subsequent text. For example, in claim 1 of the U.S. Pat. No. 7,315,682, shown in FIG. 23, terms “coupling”, “first housing”, and “slot in a side wall” are repeatedly used throughout the text. Some of the terms are exceedingly long, forming veritable text “sausages” like “pivotally connected to the protective cap”, for example. Whether the reader is or is not familiar with the meaning of the terms, his/her brain has to work hard to visually recognize these terms, to memorize them and to grasp their mutual relationships. To achieve this goal, many a patent practitioner has resorted to manually highlighting or underlining the repeating terms on a printed piece of paper or in a text editor. Another, albeit partial, remedy is to use a text editor capable of searching for a term and highlighting all its occurrences. Usually, the editor allows for only one term to be highlighted at a time. Another alternative is utilizing a web browser with highlighting abilities. There are also browser Add-ons which extend browser abilities and enable highlighting multiple terms with different colors.

All these solutions share a common shortcoming because they require the user to manually identify and enter the text to be highlighted.

Comparing claims is another often performed task. In our example, if the reader wishes to determine which claims contain the term “pivotally connected to the protective cap” they will have to carefully read all claims. This task is significantly more formidable for patents with many claims. The task is made yet more difficult if the reader wishes to examine the abstract and the body of the patent as well.

Another problem arises from the style of claim writing or the style of claim rendering where not enough line breaks are used. For example the claim in FIG. 25 consists of one monolithic paragraph. The reader is forced to invest time and effort to comprehend where the claim preamble stops and what the major parts of the claim are. As a remedy, the writer of these lines has sometimes resorted to manually copying the text of the claim into a text editor and manually inserting line breaks.

Usually, the fastest way to understand a patent is to read independent claims. Patents with many claims require the reader to invest time and energy to identify these claims among the dependent ones. Since independent claims are scattered among the dependent ones, even more effort is needed if the reader wishes to ascertain differences between the independent claims. Often, reading the shortest independent claim gives the quickest way of comprehending patent. Finding this claim requires effort in cases with many claims.

Another problem when trying to comprehend a patent is lack of pertinent information or a cumbersome interface which requires additional scrolling or clicking. For example, the very popular Google Patents web site doesn't offer priority date of a patent on its patent overview page, as shown in FIG. 20. To get this information, the reader is forced to go to the USPTO web site for the patent or to view the patent in the PDF format. Further, as FIG. 20 shows, patent abstract is shortened which makes the remaining abstract text rather useless. Further, the page shows the Examiners, Attorneys and the U.S. Classification data which are all details rarely referenced. Here, an attempt was made to save the space by truncating the abstract just to waste it on information of marginal importance.

To make the matters worse, both Google and USPTO sites show the full list of Citations before the claims, even though the full list of citations is a rarely needed piece of information. This forces the reader to scroll down to reach the claim text. Usually, it is of more importance to know only the number of citations since this sometimes indicates how thorough prior art search was undertaken when the patent was drafted and prosecuted.

Another example of a cumbersome interface is the layout of the USPTO web site which shows patent bibliographic data on the top of the page followed by the claims, as shown in FIG. 22. Patent bibliographic data contains information rarely useful for the majority of readers, like the places of residence of inventors (“Tustin Calif.”, “Long Beach CA”), assignee headquarters city and state (“Irvine, Calif.”), Current U.S. Class etc. The reader is therefore forced to scroll down to read the claims.

Yet another example of a cumbersome interface is the title of the web page for Google Patents and USPTO patent page. As shown in FIG. 20, Google's Patent page doesn't contain indication of the patent number and instead just shows part of the patent title: “Fiber optic protective shutt . . . ”. As shown in FIG. 22, USPTO page title shows “U.S. Pat. No. 7,315 . . . ” which contains even less useful information. The consequence of this is that when user opens multiple patents in multiple tabs in a browser window, he/she has very little indication as to which tab belongs to which patent.

Yet another problem arises when the reader wishes to view multiple patents, for example when reading an article mentioning several patents. The reader is forced to copy and paste the patent numbers one by one into, for example, Google Patent search page. This action requires attention since it will fail if, for example, the patent number entered has a space character concatenated at the end.

Yet another problem is encountered with reissued patents. FIG. 28 shows such a patent on the USPTO web site. The difficulties in reading this text are better left without description.

### SUMMARY

The present invention relates generally to a system and method for analyzing and viewing text and image data, and more specifically, for analyzing and viewing patent data.

In one embodiment, certain terms in the patent text are automatically underlined with lines of different types. The terms are chosen to enable the user to grasp the patent content more easily and quickly. In one embodiment, the terms are chosen according to their frequency. In another embodiment, the terms are chosen according to their relative importance. Each term has an associated line type. Advantageously, underline types are organized into groups to allow the user to show more or less underlines with minimal effort. Also, the user can remove or change individual underlines with minimal effort.

In yet another aspect, claims are sorted automatically so that shortest independent claims are shown on top in order to present the user with the easiest claims to grasp first. The claims can be reordered according to their numerical order.

In yet another aspect, user interface is advantageously organized to show the data which is more frequently referred to on top. The data which is referred to less frequently is included on the bottom of the user interface and is accessible via convenient links.

In yet another aspect, claim text is automatically broken into paragraphs in order to provide the user with a format which is easier to grasp.

In yet another aspect, an interface is provided for opening multiple patents at the same time with minimal effort.

In still another aspect, favicons showing the last three digits of the patent number are used to easily identify which tab corresponds to which patent.

In yet another aspect, positions of all occurrences of an underlined term are indicated using markers positioned on the far right side of the page, next to the scroll bar.

Other aspects will become apparent from the following description.

### BRIEF DESCRIPTION OF THE DRAWINGS

FIG. 1 shows the top of the user interface in the preferred embodiment;

FIG. 2 shows the middle portion of the user interface in the preferred embodiment;

FIG. 3 shows the bottom portion of the user interface in the preferred embodiment;

FIG. 4 shows the preferred embodiment when no checkboxes are checked;

FIG. 5 shows the preferred embodiment when only the first checkbox is checked;

FIG. 6 shows the preferred embodiment when all checkboxes are checked;

FIG. 7 shows the preferred embodiment when only the third checkbox is checked;

FIG. 8 shows the preferred embodiment when claims are reordered according to their numerical order;

FIG. 9 shows the preferred embodiment when clicking on the “BRIEF DESCRIPTI . . . ” link;

FIG. 10 shows the preferred embodiment after clicking on the “BRIEF DESCRIPTI . . . ” link;

FIG. 11 shows the first step of reassigning “configured to cover” underline to “fiber optic” in the preferred embodiment;

FIG. 12 shows the second step of reassigning “configured to cover” underline to “fiber optic” in the preferred embodiment;

FIG. 13 shows the third step of reassigning “configured to cover” underline to “fiber optic” in the preferred embodiment;

FIG. 14 shows the first step of removing “slot in a side wall” underline in the preferred embodiment;

FIG. 15 shows the second step of removing “slot in a side wall” underline in the preferred embodiment;

FIG. 16 shows the third step of removing “slot in a side wall” underline in the preferred embodiment;

FIG. 17 shows the home page of the preferred embodiment;

FIG. 18 shows the home page with text pasted into it and patents opened in new tabs in the preferred embodiment;

FIG. 19 shows the home page with URL and Excel links listed in the preferred embodiment;

FIG. 20 shows the Google Patent web site, top of the page;

FIG. 21 shows the Google Patent web site, claims;

FIG. 22 shows USPTO web site, top of the page;

FIG. 23 shows USPTO web site, claims;

FIG. 24 shows USPTO web site, body of the patent;

FIG. 25 shows an example claim with no breaks;

FIG. 26 shows the same claim in the preferred embodiment with text broken after each comma and colon;

FIG. 27 shows the same claim in the preferred embodiment with text broken after the colon;

FIG. 28 shows text of an reissued patent on the USPTO web site;

FIG. 29 shows text of an reissued patent without deletions in the preferred embodiment;

FIG. 30 shows text of an reissued patent with inserts and deletions in the preferred embodiment;

FIG. 31 shows patent body with figure references in the preferred embodiment;

FIG. 32 shows patent body with patent FIG. 2 shown on the bottom of the window in the preferred embodiment;

FIG. 33 shows top portion of the web browser with five tabs for five open patents.

FIG. 34 shows top portion of the web browser with eleven tabs for eleven open patents and a far left tab for the home page.

FIG. 35 shows prior art Google Patent web site with the same 11 patents open.

FIG. 36 shows underline for n-gram “system” on top of another underline.

FIG. 37 shows the same claim as in FIG. 36 as rendered in Internet Explorer.

FIG. 38 shows the same content as FIG. 1 with position markers corresponding to text “protective cap”.

FIG. 39 shows a pop-up window used for specification text look up

### DETAILED DESCRIPTION

In the preferred embodiment, a public web site allowing easier and faster ways for finding and comprehending patent data is presented.

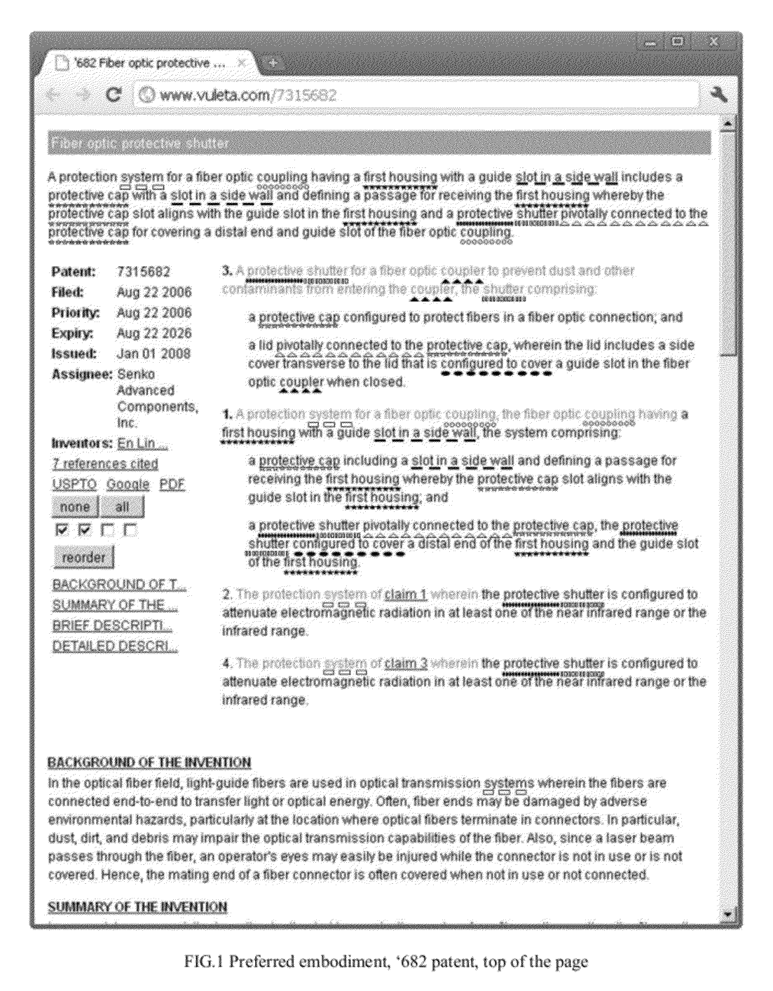

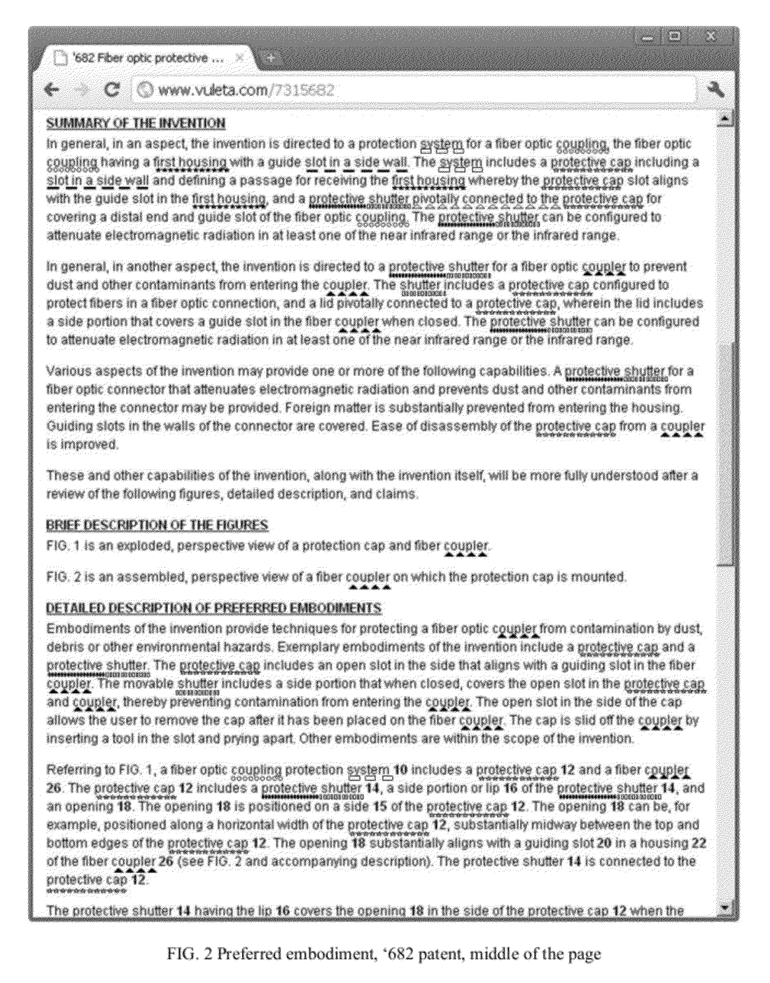

Referring to FIG. 1, web page of U.S. Pat. No. 7,315,682 is shown. The page title in the browser tab (“682 Fiber optic protective . . . ”) shows the last three digits of the patent number followed by the patent title. Patents are often identified by the last three digits, thus maximizing the amount of useful information in the available space. When the user opens multiple tabs this still gives an indication as to which tab belongs to which patent. The last three digits of the patent number are preceded by an apostrophe to indicate the patent number was shortened.

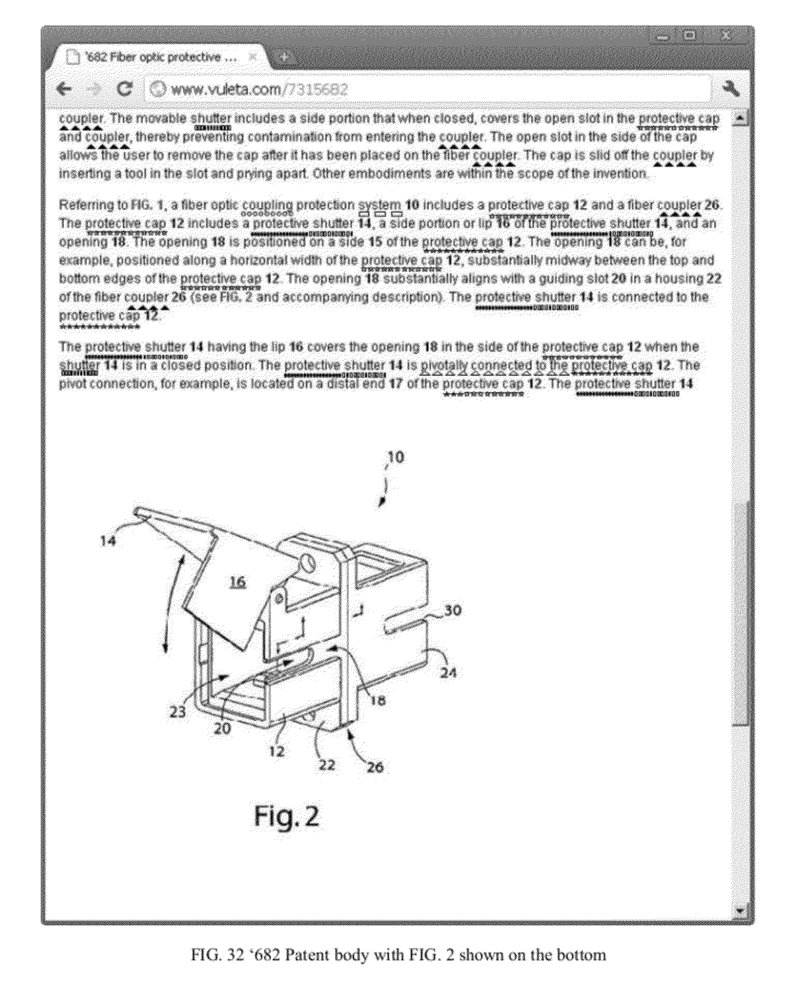

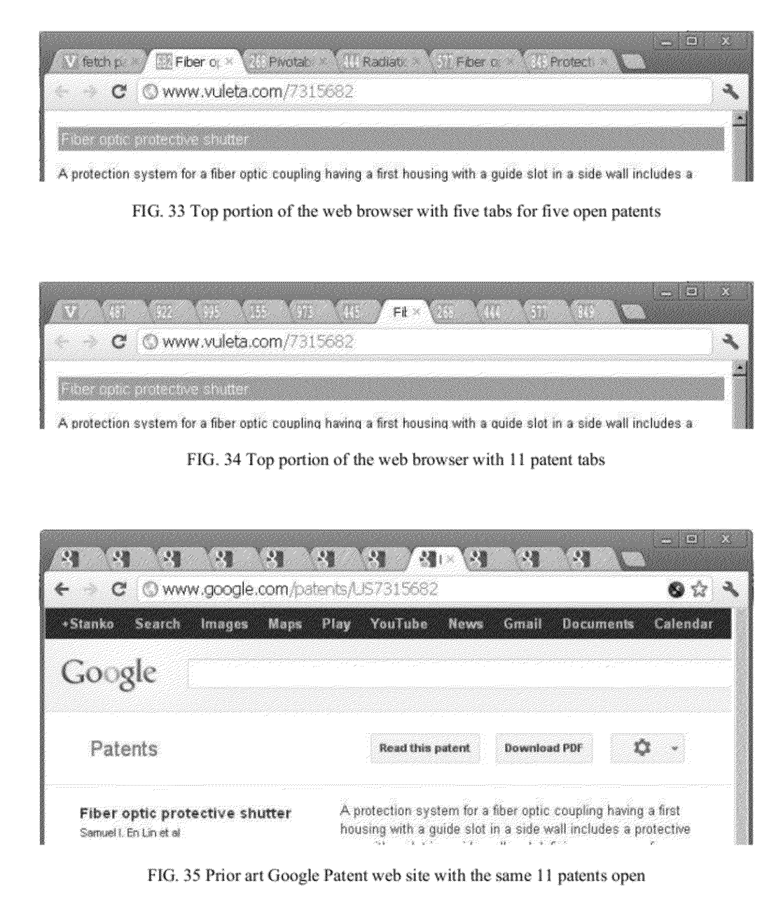

In another embodiment, shown in FIG. 33, the last three digits of the patent number are shown in the favicon icon. The figure shows the top portion of a web browser with five tabs for five patents. FIG. 34 further illustrates the advantage of using favicon icon to show the last three digits. Finding the particular patent among the 11 open patents is an effortless task. Besides granted patents, the same can be done for applications or foreign patents and applications.

FIG. 35 shows prior art Google Patent web site with the same 11 patents open. As can be seen, the only way for the user to identify which tab hides the patent she or he is interested in is to click on the tabs (or use Control-TAB keys) until the proper patent is found.

It is also common to refer to a patent according to its inventor. Hence, in another embodiment, it is possible to use favicons to display first two or three digits of the inventors' name. As will be shown later in the text, when implementation details are discussed, this solution requires creating many more favicon icons.

The address line of the page (“www.vuleta.com/7315682”) contains the patent number. The web site accepts various versions of the address link: with or without .html, with or without .htm, with or without the comma, with or without leading zeros, with or without “US” prefix, with or without “USPAT” prefix. For example, all these forms would be acceptable: “www.vuleta.com/7,315,682”, “www.vuleta.com/USPAT07315682”, “www.vuleta.com/U.S. Pat. No. 7,315,682.html^{”}, “www.vuleta.com/us7,315,682.HTM”. The purpose of this is to free up the user from having to memorize any particular form or to edit the patent number to fit a particular form.

The title is followed by the patent abstract. Below the abstract, on the right, the claims are shown.

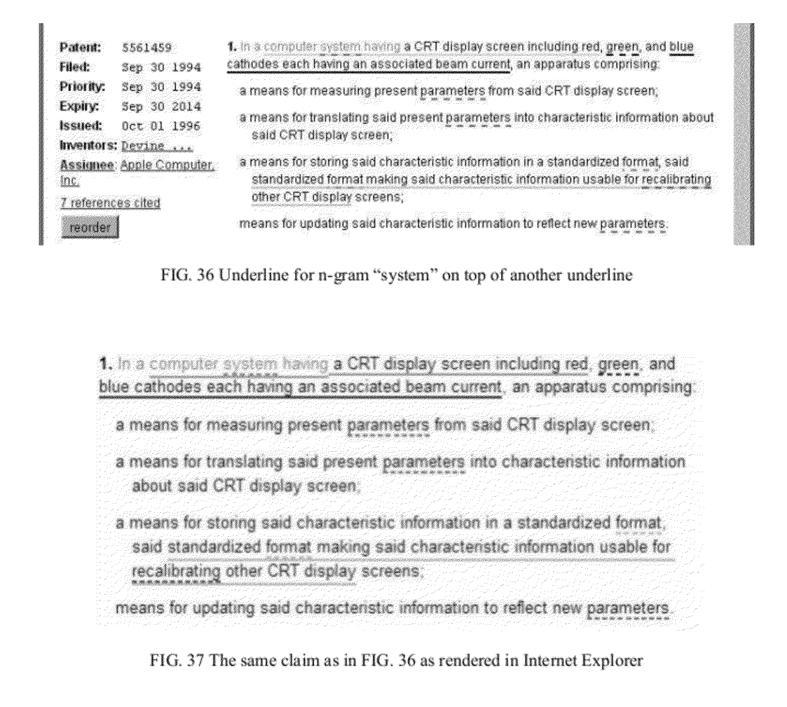

Further referring to FIG. 1, some parts of the text in the abstract, the claims and the body are underlined with lines of different types. The types differ by pattern and color. Please not that, because color can not be shown in this document, underlines of different colors have been replaced with black and white lines utilizing different patterns. (An unintended consequence of this is that it is more difficult to follow the text without color.) FIG. 36 and FIG. 37 show the preferred embodiment in its original form, as it appears in a web browser. This form uses lines of different colors and three forms: solid, dotted or dashed.

The purpose of the underlines is to help the reader grasp the material more quickly and with less effort. For example, the first glance reveals that “protective cap” is an often repeated term. Also, it is easy to see that claim 1 has “first housing” term repeated several times, while the claim 3 doesn't. As well, while reading claim 3, the reader can use peripheral vision to keep track of the term “first housing” while reading the claim. It is also easier to compare claims. For example, it is easy to see that “pivotally connected to the protective cap” term is present in both independent claims, while “slot in a side wall” is present only in claim 1. The terms are underlined throughout the text: in the claims, abstract and the body of the patent.

Although other embodiments may use different types of highlighted background instead of underlines, the preferred embodiment uses underlines in order to provide the needed visual clues without overwhelming reader's visual cortex.

The underlined terms are chosen automatically from within the independent claims text. This is done because independent claims are the most important part of the patent.

Once the terms are chosen, all the patent text is underlined accordingly, including the dependent claims, the abstract and the body of the patent. The reader can focus hers/his attention to the independent claims and can quickly ascertain where these terms are used in the rest of the patent text.

How the underlined terms are chosen will be explained later.

Further referring to FIG. 1, to help the reader distinguish claim preamble from the rest of the claim, the preamble font is gray. The rest of the claim text is black. The end of the preamble is determined by searching the text for the first occurrence of one of these phrases: “comprising”, “comprises”, “including”, “containing”, “characterized by”, “consisting of”, “comprising at least”, “composed of”, “consisting essentially of”, “characterized in that”, “having” and “wherein”. Most of these phrases are defined in the Manual of Patent Examining Procedure (MPEP), 2111.03 Transitional Phrases [R-3].

By default, independent claims are sorted by their length, with the shortest claim on top, while the dependent claims are listed in their numerical order. Referring to FIG. 1, the two independent claims 3 and 1) are listed prior to the dependent claims 2 and 4). The purpose of this is to draw attention of the reader towards the claims which require the least amount of time and effort to understand them. When trying to grasp patent material, independent claims are more important and are therefore listed first. With this arrangement, the reader is spared the effort of scrolling through all the claims to find the independent ones.

Listing the shortest independent claims first is especially useful for patents with a large number of claims and with one or more short independent claims with high claim numbers.

To easier distinguish independent from dependent claims, independent claim numbers are shown in bold font. References to independent claims in the dependent claims are HTML links to the claim referenced.

Further referring to FIG. 1, below the abstract and on the left, basic patent bibliography data is shown: patent number, date of filing, priority date, expiry date, date of issue, assignee and inventors.

Priority date is the oldest date of applicable provisional applications priority dates, non-provisional priority dates and international priority dates.

If the patent has expired (compared to the date the page is viewed), the expiry date is shown in red.

Date of issue is followed by the list of assignees which, in turn, is followed by the Inventors field. If the list of inventor names is longer than 10 characters, only the first 7 characters are shown, followed by three dots (“En Lin . . . ”). This is an HTML link pointing to the heading “INVENTORS” on the bottom of the document, as shown in FIG. 3. The heading is followed by the full list of inventors.

The items in the bibliography section are equipped with HTML “title” attributes. When the cursor is left hovering over an item, a helpful text pops up giving more information about the item. For the “Filed” field the text is “Date the patent application was filed in the US.”. For the “Priority” field, the text is: “Priority date. May not be correct.” For the Expiry field, the text is: “Patent expiry date. May not be correct. Red if expired.”. For the “Issued” field, the text is “Patent grant date.”

For the “Assignee” text, the pop up text is “USPTO Assignment records for this patent”. In one embodiment, when clicked on “Assignee”, web page is opened in another tab with the URL: “http://assignments.uspto.gov/assignments/q?db=pat&pat=7315682”, listing all the assignees for this patent in USPTO records. In another embodiment, assignee records processed and stored on the vuleta.com server (or servers) are opened.

For the Assignee value (“Senko Advanced Components, Inc” in the example), the text is “Click to see all patents owned by this company”. In one embodiment, clicking on the this field leads to: “https://www.google.com/search?tbm=pts&tbo=1&h1=en&q=inassignee:Senko+Advanced+Components,+Inc.” In another embodiment, similar records on the vuleta.com server (or servers) are retrieved.

The bibliography section is designed to provide maximum of useful data without burdening the interface with information which is less often referenced, like names of attorneys, full list of inventors or classification data. In another embodiment, this information is available on the bottom of the page in similar fashion as the list of references cited or the list of inventors.

The list of inventors is followed by a link to the list of patents referenced by this patent (“7 references cited”). The text of the link contains the number of cited patents (7 in this case) since this is sometimes valuable information indicating the quality of the prior art research undertaken during patent drafting and prosecution. Clicking on the link shows the list of referenced patent documents on the bottom of the page (FIG. 3). Each patent number in the list is itself a link to the corresponding patent or the application on the same web site.

The link to the references cited is followed by links to the patent data on the different other sites.

USPTO web site: “PTO”, URL “http://patft.uspto.gov/netacgi/nph-Parser?Sect2=PTO1&Sect2=HITOFF&p=1&u=%2Fnetahtm1%2FPTO %2Fsearch-bool.html&r=1&f=G&1=50&d=PALL&RefSrch=yes&Query=PN %2F7315682”.

Google Patent web site: “Google”, URL “http://www.google.com/patents?vid=USPAT7315682”.

Patent document in the PDF format: “PDF”, URL “http://www.google.com/patents/?vid=USPAT7315682&output=pdf”.

In another embodiment, there is a link to the patent information on the European Patent Office site available: “Espace” (not shown). In one embodiment, clicking on this link opens the patent page with patent kind code A: “http://worldwide.espacenet.com/publicationDetails/biblio?CC=US&NR=7315682A&FT=D”. In another embodiment, it opens the page with patent kind code B: “http://worldwide.espacenet.com/publicationDetails/biblio?CC=US&NR=7315682B&FT=D” (this URL actually opens B1 kind code page). In yet another embodiment, clicking on this link results in opening both A and B1 kind codes. This is useful because some US patents are stored on the Espace site with kind code A, and others with kind code B1. Opening both links ensures that at least one version of the patent on the Espace site will be located properly.

In another embodiment, there is also provided a link to USPTO PAIR database information for this patent.

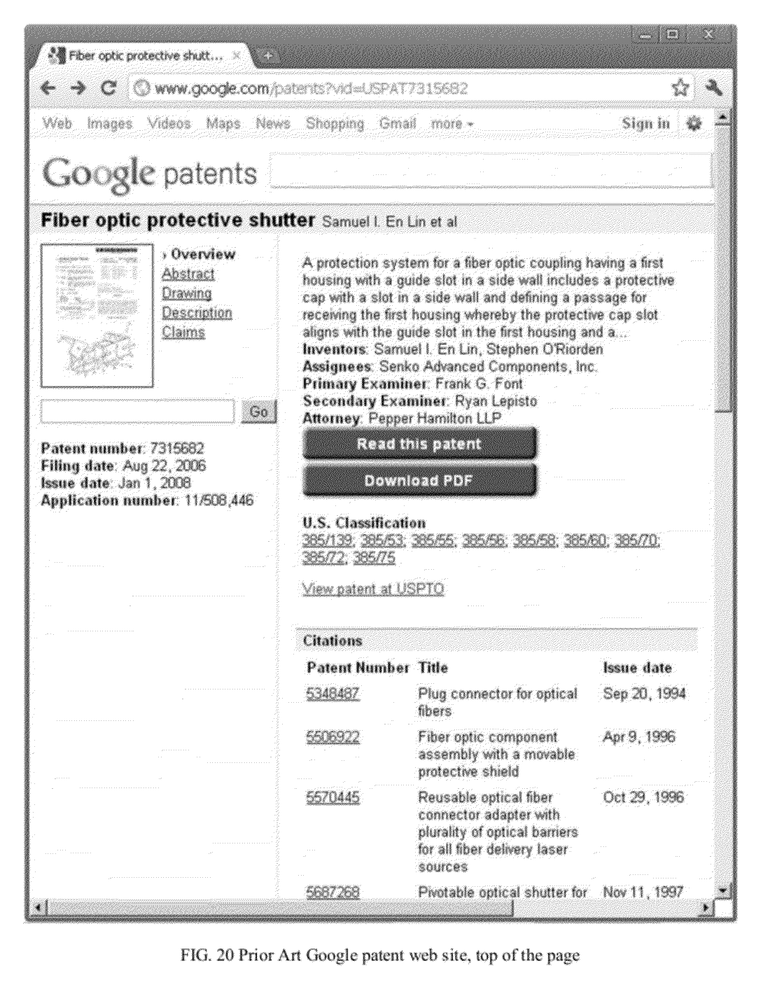

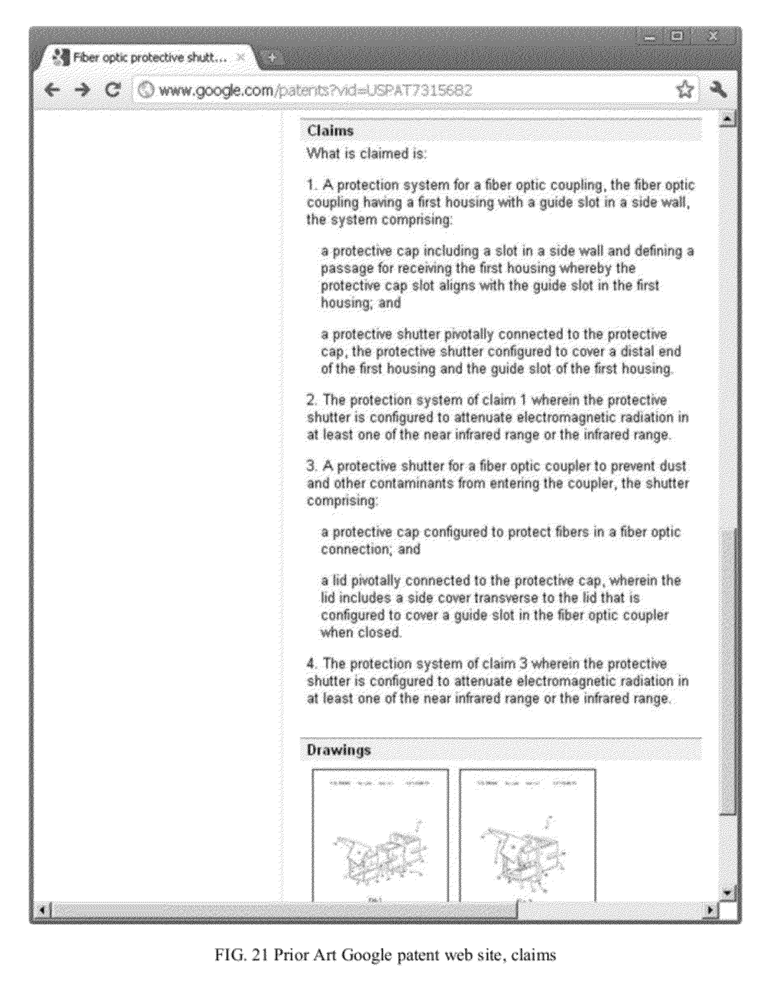

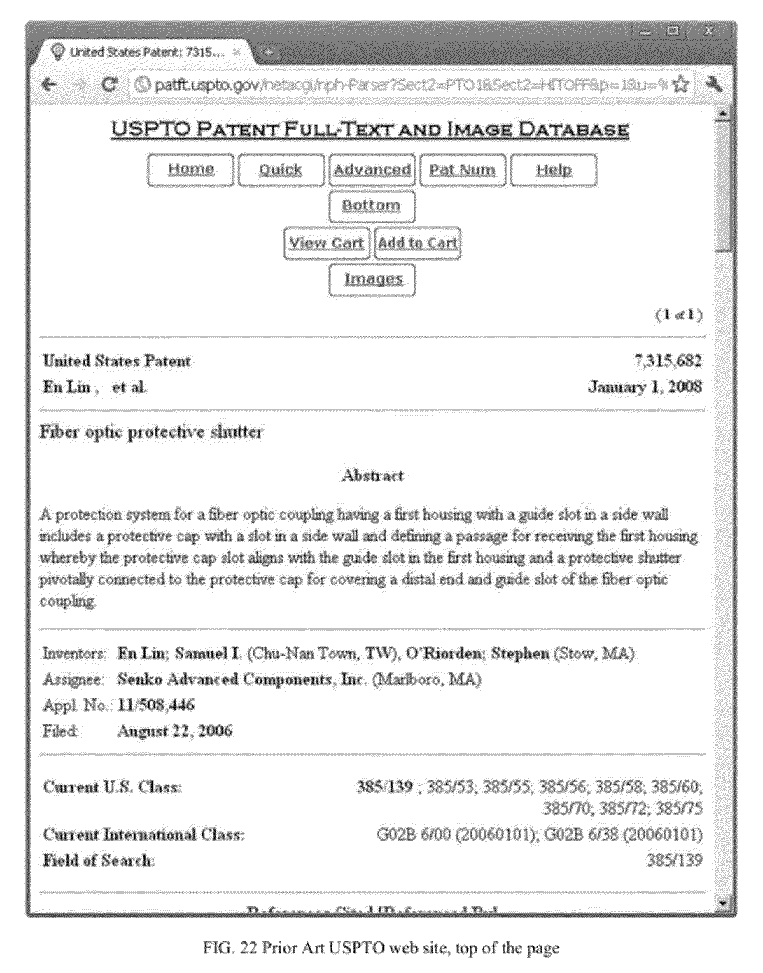

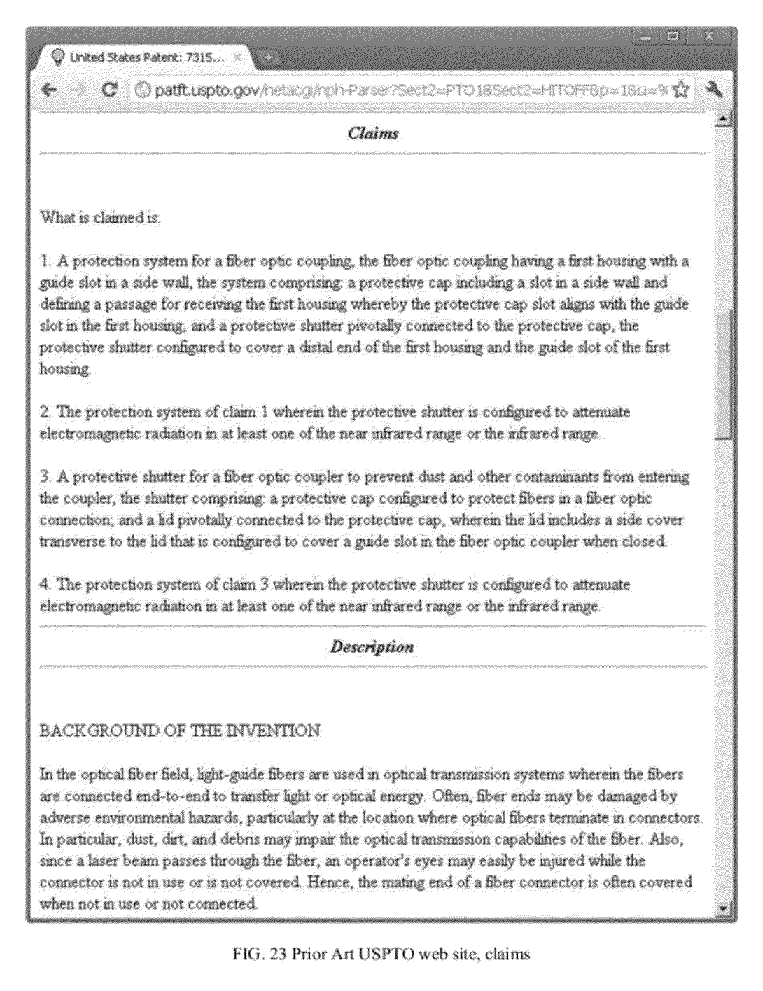

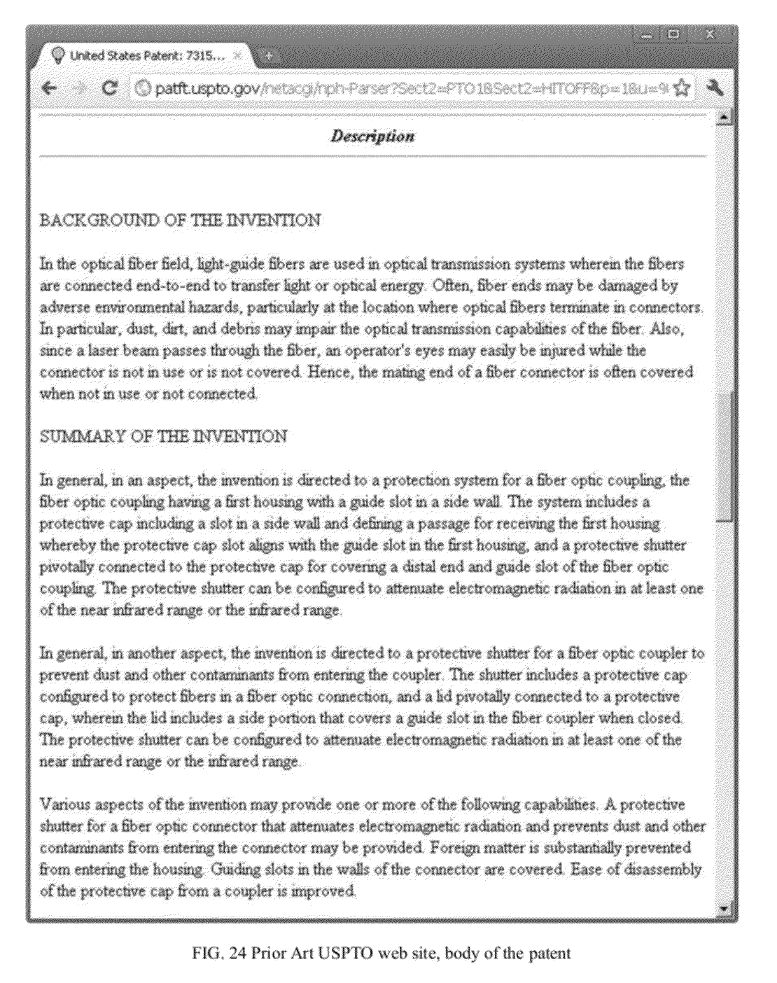

The purpose of these links is to provide users with easy access to patent information from different sources. Clicking on the USPTO link opens the USPTO site shown in FIG. 22. Clicking on the Google link opens Google patent site in another tab (FIG. 20). The format of these three links shows, again, frugality with the user interface space—instead of the long links evident on the Google patent site (FIG. 20), like “Download PDF” and “View patent at USPTO”, only “PDF” and “Google” are used here. After clicking these links the first time, the user will easily learn the purpose of the links so any more text is not needed. Therefore, the user is offered a more spartan interface and his/her visual cortex is not forced to eliminate unnecessary clutter in order to identify useful information.

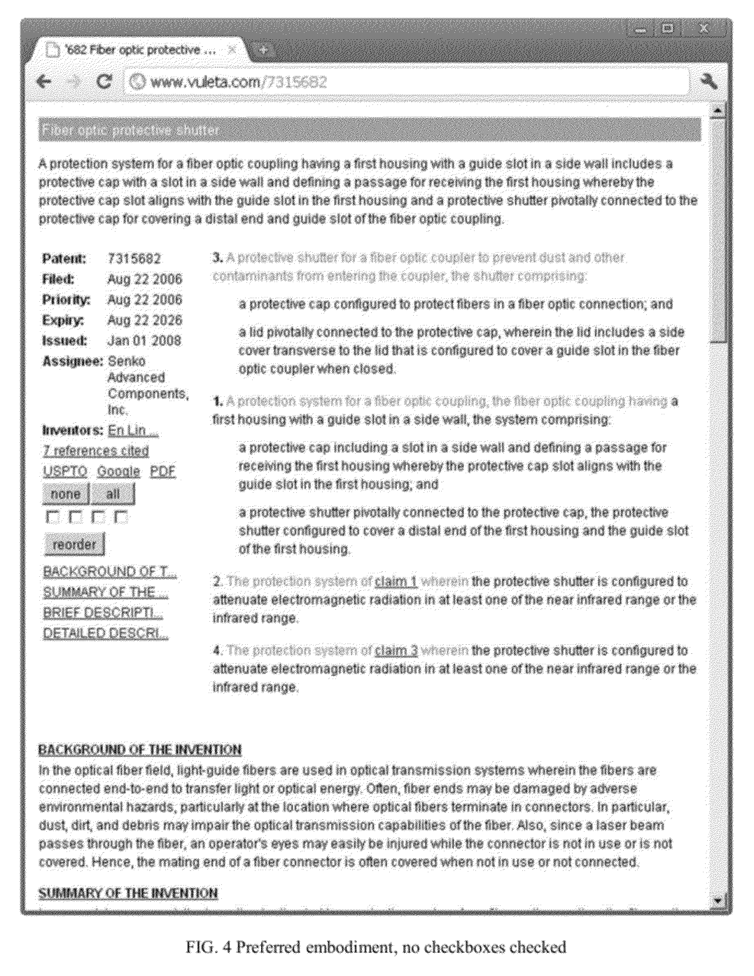

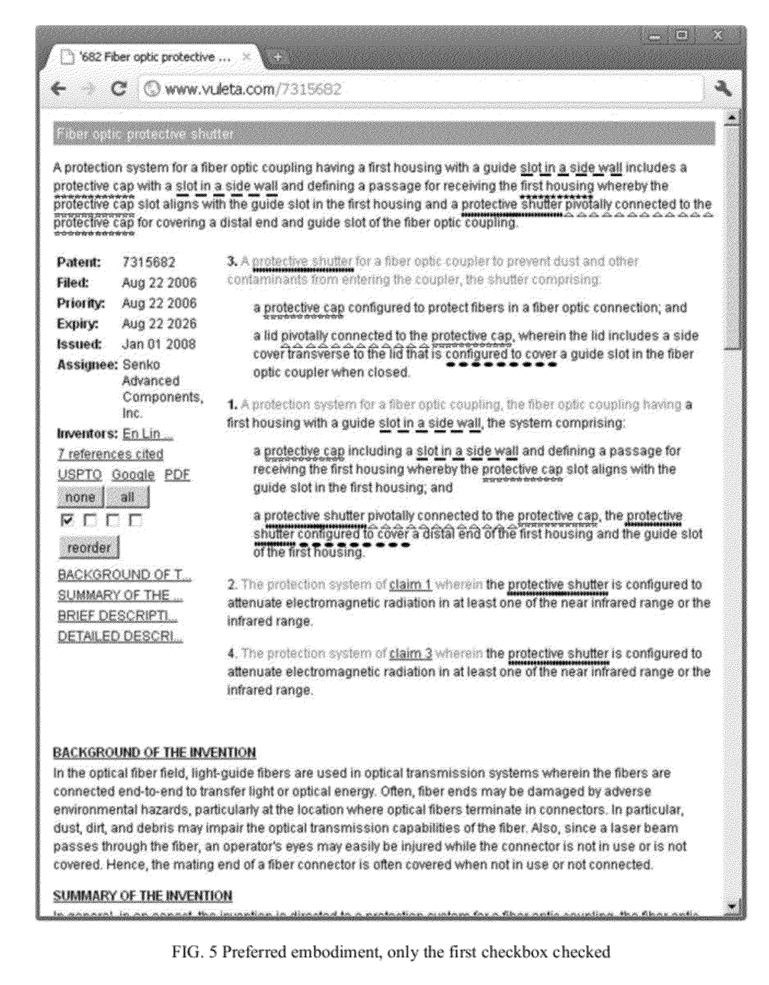

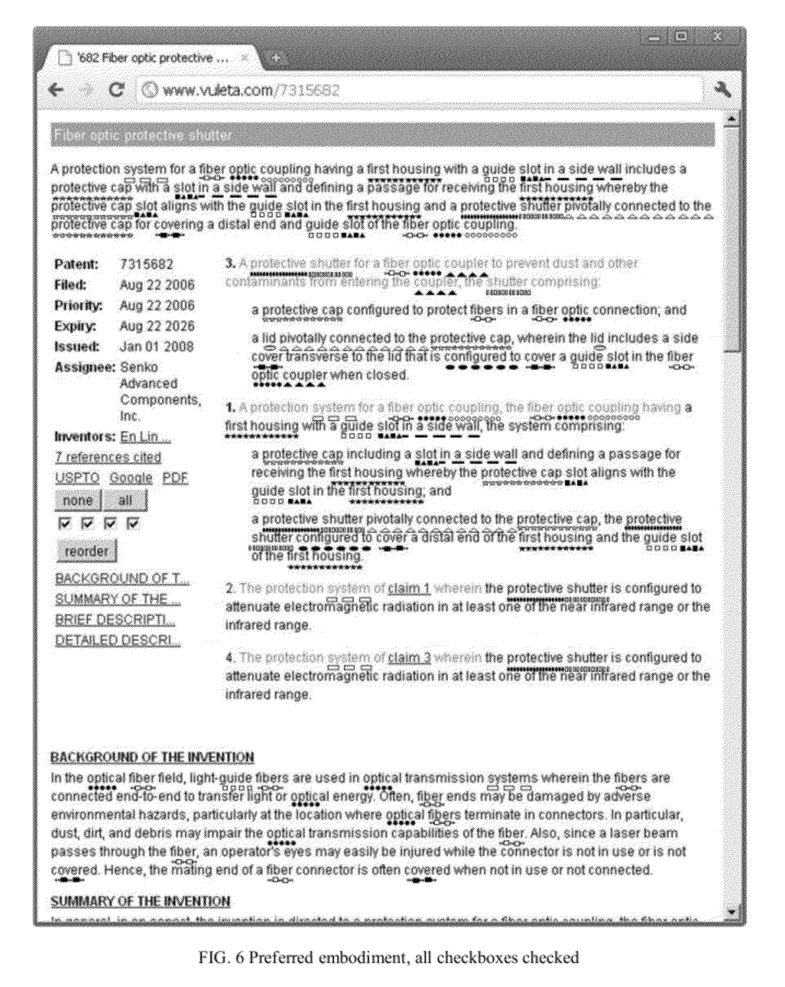

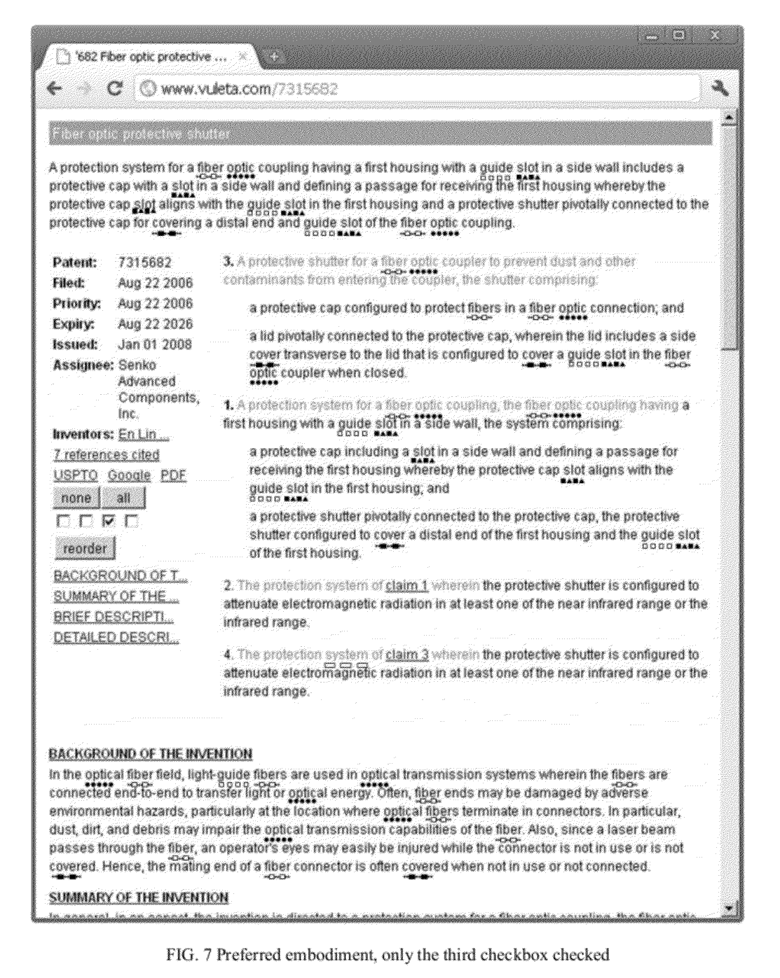

Again referring to the FIG. 1, USPTO, Google and PDF links are followed by “none” and “all” buttons. Button “none” hides all the underline lines, while the button “all” shows them all. They are equipped with HTML “title” attributes “remove all underlines” and “show all underlines”, respectively. These buttons are related to the four checkboxes below. The purpose of these checkboxes is explained in their title attributes: “show longest underlines”, “show long underlines”, “show short underlines” and “show shortest underlines”, respectively. All the underlined terms are divided into four groups according to their length. Those with the same number of words are further sorted according to the number of characters. These checkboxes turn the underlining for these four groups on and off. The effect of these buttons is evident in FIGS. 4, 5 and 6. The default version of the page has the two longest groups turned on. In some cases, underlining too many terms clutters the view and burdens reader's visual cortex with too much information to process. This feature gives a convenient way of turning off the unnecessary underlines to reduce visual clutter. For example, if the user was interested in “protective shutter” only, they can turn off all the checkboxes except for the first one (FIG. 5). If the user was interested in “fiber”, he/she can turn off all the checkboxes except the third one (FIG. 7).

In other cases, there can be too much text with no underlines, which then calls for turning on more underlines than what is delivered by default. This can be the case for patents with many long claims.

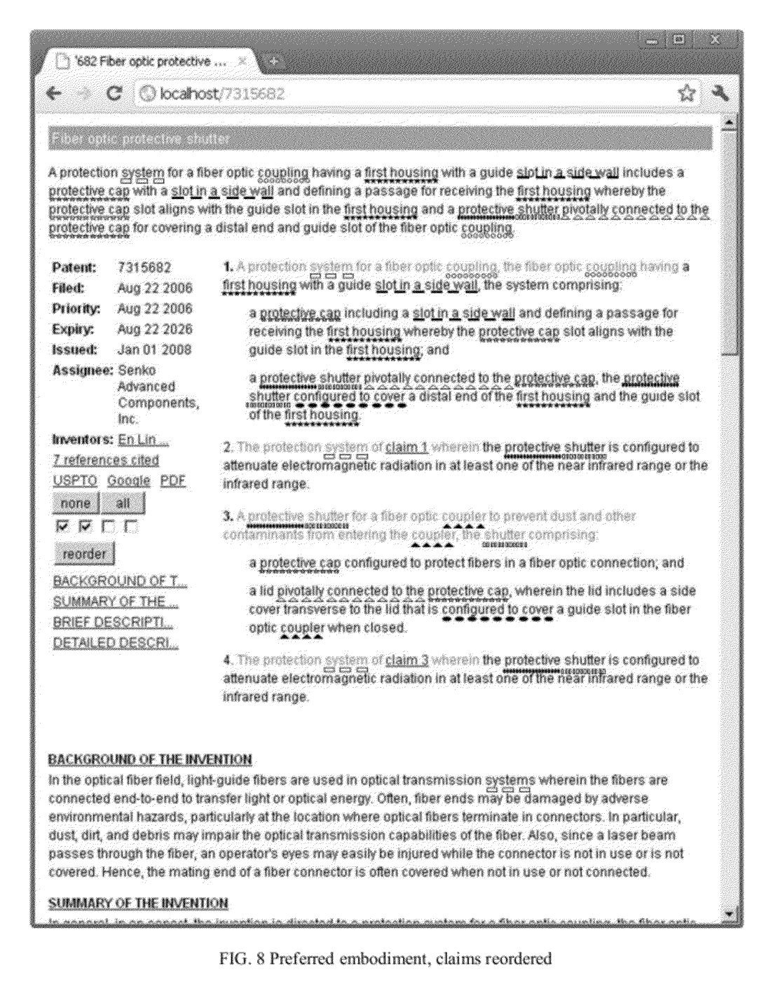

Referring to FIG. 1 again, there is a “reorder” button below the four checkboxes. Clicking the button reorders the claims according to their numerical order (FIG. 8). Because the independent claim numbers are shown in bold, it is still easy to spot independent claims, which is especially helpful for patents with many claims. Clicking the button again reorders them back with the shortest independent claims on top, as explained above. This button is equipped with the HTML title: “Reorder claims: shortest independent claims on top or proper claim order”.

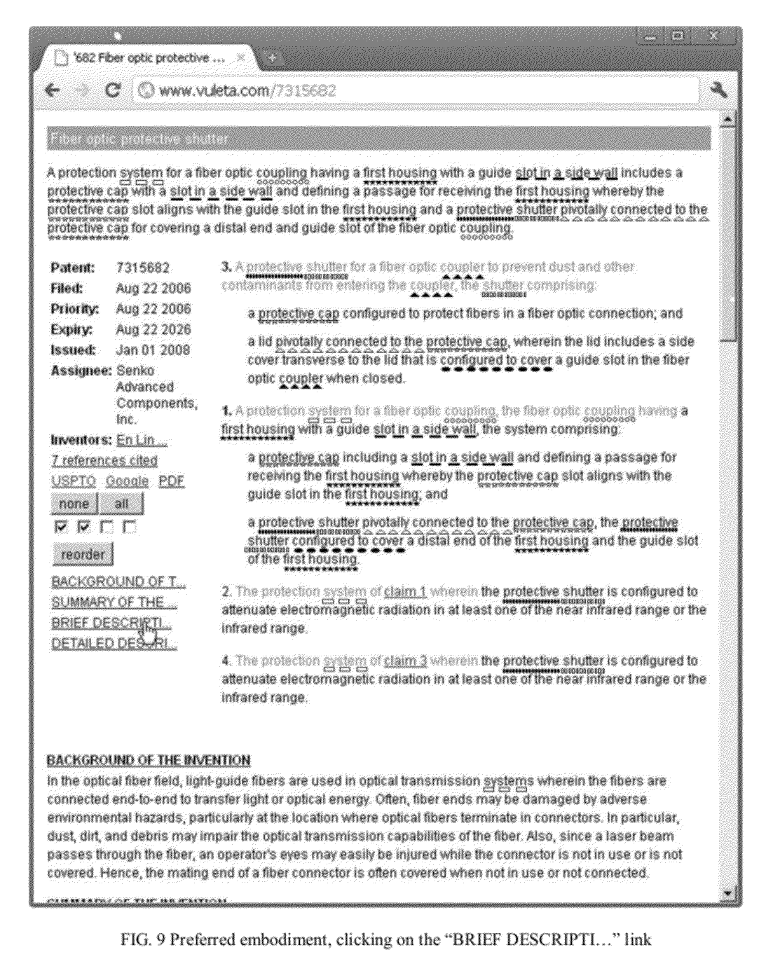

Referring to FIG. 1 again, there are four links below the “reorder” button. These are links to the headings in the body of the patent. When creating the links, if the heading text has more than 17 characters, the text is truncated to 15 characters and concatenated with “ . . . ” to indicate truncation. Clicking on the link brings into view the heading pointed to. The headings themselves (in the body of the patent), are HTML links pointing to the top of the page. These links are also equipped with the HTML “title” attribute which pops up text “back to top” when cursor hovers over the heading. It is important to note that, when the user clicks on the heading link, the heading is positioned to where the cursor was when the link was clicked. (This is different from the default behaviour of HTML links and anchors which show the text referred to on the top of the browser window.) For example, if the user clicks on the “BRIEF DESCRIPTI . . . ” link (FIG. 9—note the cursor position), the heading “BRIEF DESCRIPTION OF THE FIGURES” will be positioned at the same height as to where the “BRIEF DESCRIPTI . . . ” link was (FIG. 10). Similarly, when the user clicks on the heading (to return back to top), vertical offset of the page is again adjusted so the cursor again points to the same original place, as shown in FIG. 9. This is especially useful in the case when the page is viewed on a smaller screen like mobile phone or a pad (where not all the text between the cursor and the top of the page can fit on the screen). In another embodiment, clicking on the heading to return back to top simply aligns the top of the page with the top of the window without adjusting vertical offset. These links therefore allow the user to look up the content in the body of the patent with only two clicks, without even moving the mouse. This is done for two reasons: user's eye was already trained to this section of the page so the user doesn't have to move the eyes or scroll the text to see the desired text. The second reason is that the cursor is positioned on the target heading already so the user can click on it immediately without searching for the heading and moving the cursor.

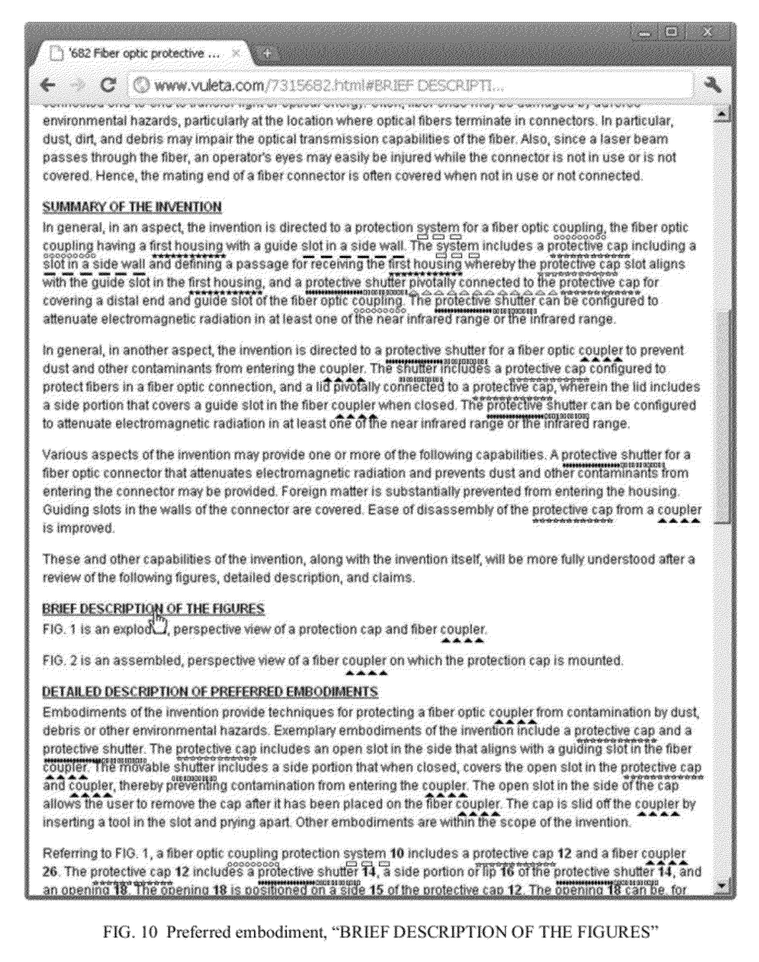

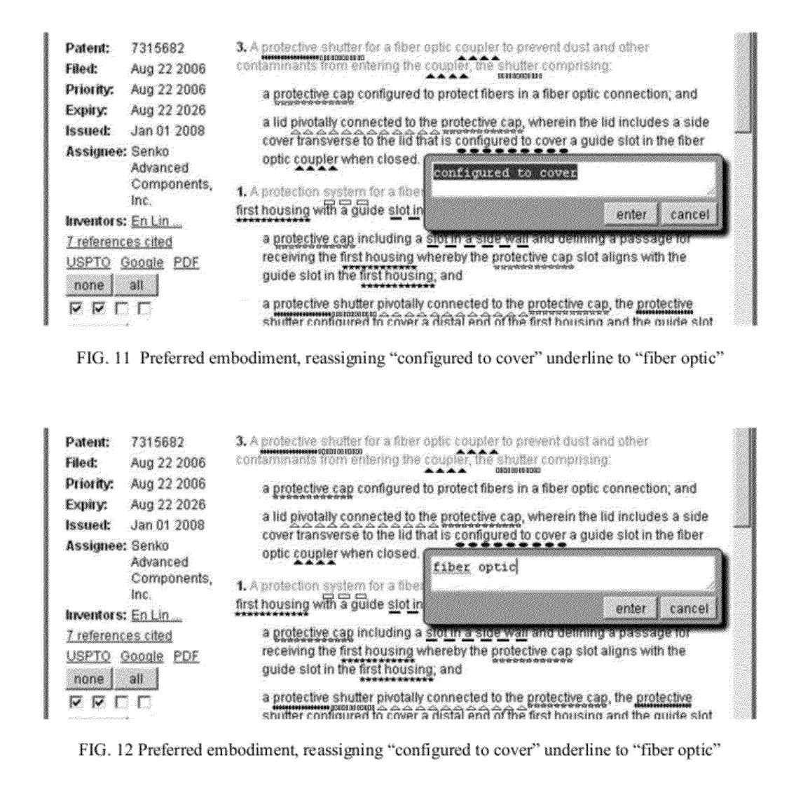

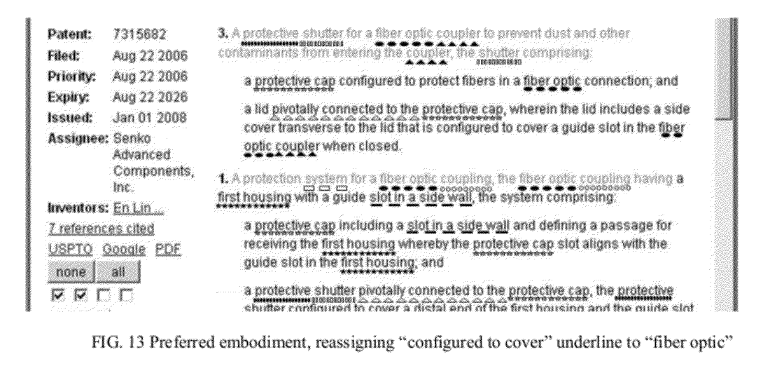

Referring now to FIG. 11, another feature is illustrated. When user double-clicks on an underlined text, a text box with text area and two buttons pops up. In the example, the user double-clicked on the “configured to cover” text. The clicked-on text is already selected in the text box. This spares the user from having to select it manually and allows for easy erasure or replacement with another text. As is shown in FIG. 12, in our example, the new text “fiber optic” was typed in or pasted into the text box. After the “enter” box is clicked on, the underline was moved from the “configured to cover” text to the “fiber optic” text. This feature allows the user to reassign the underlines from a not so important text to more important text with minimal effort. The end result is shown in FIG. 13.

In another embodiment, assigning underline to text is achieved by selecting new text by either double clicking on a word or clicking and dragging. Upon selection, a pop up window appears with the selected text and several colored lines next to it. Clicking on any of the colored lines assigns it to the text. If the user selects only part of the word, this entire word is included in the selection. For example, referring to FIG. 1, if the user selects “ber optic connect”, the pop up window shows “fiber optic connection”. This makes it easier to select the text since the user doesn't have to precisely select the start and the end characters.

In yet another embodiment, user selected underlined text is additionally shown in bold font. In yet another embodiment, user selected text is shown as highlighted (in the chosen color) instead of underlined. This is to make it easier for the user to spot it on the page.

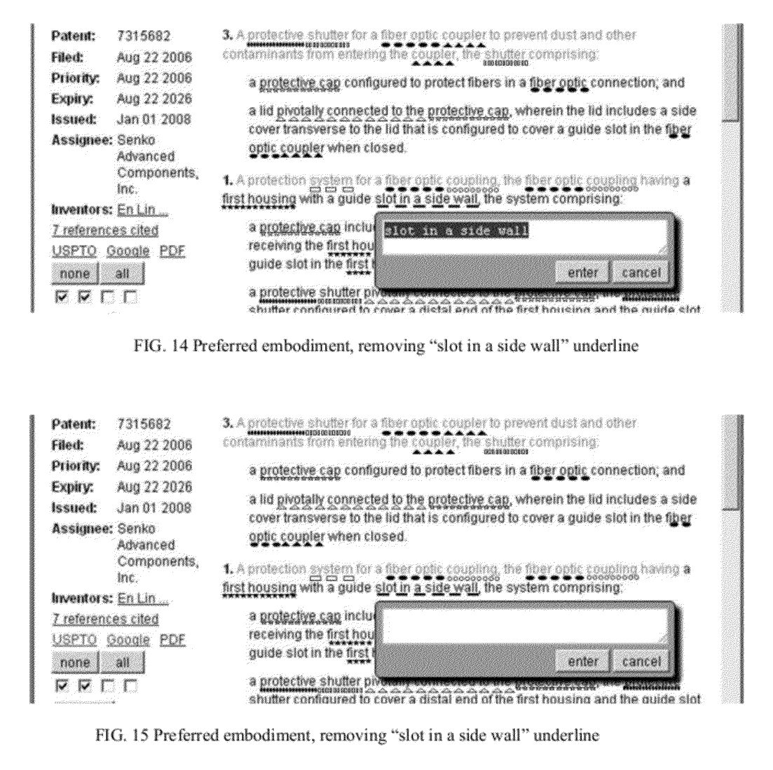

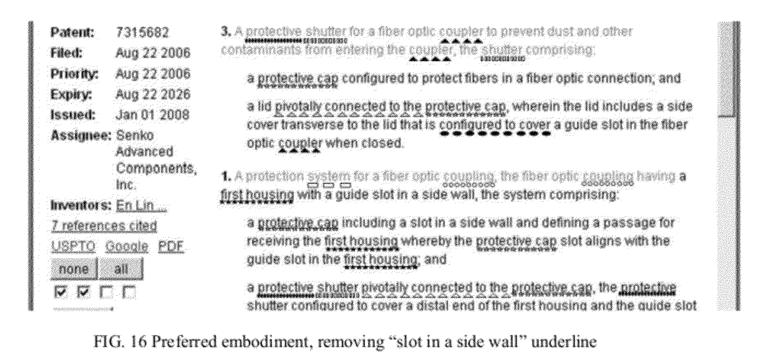

FIGS. 14, 15 and 16 show how an underline can be removed altogether in the preferred embodiment. In our example, text “slot in a side wall” was deleted altogether in the textbox which resulted in the underline being removed. This feature allows for fast and easy decluttering to lessen the burden on the user's visual cortex.

In another embodiment, showing or removing underlines is achieved by selecting a portion of text, by either clicking and dragging or double-clicking. As soon as text is selected, a pop up window is shown with the list of underlined portions of text included in the selection, partially or completely. Next to each underline, a checkbox is shown. For example, referring to FIG. 1, if the first line of abstract was selected, the pop up window would show four lines of underlined text: “system”, “coupling”, “first housing” and “slot in a side wall”, with a checkbox in each line. Checkboxes serve to turn the respective underline on or off.

In yet another embodiment, selecting a portion of text anywhere on the page results in a pop up window which shows the text from the specification (but not from the claims) surrounding the selected portion. Referring to FIGS. 1, 2 and 3, for example, if “coupling” is selected, the pop up window shown in FIG. 39 appears with five lines of text where the word “coupling” is mentioned.

Note that the word coupling is shown in bold to make it easier to spot. As well, the text is vertically aligned on the word “coupling”. This feature may be used to look up meaning of a term defined in the specification. In yet another embodiment, clicking on a line in the pop up window brings into view the text containing the line. For example, clicking on the second last line starting with “Referring to FIG. 1” brings into view the second paragraph of the DETAILED DESCRIPTION OF THE PREFERRED EMBODIMENTS so that the target line with “coupling” (first line of the second paragraph) is at the same vertical position as the cursor. If the user clicks on this line without moving the cursor, he/she is brought back to the same pop up window. Here, the behaviour is similar to the links to headings, explained above. If, however, user scrolls the page or moves the cursor away from the target line, the pop up window vanishes and clicking does not bring the view back to it. This feature makes it even easier to look up text from the specification. Person skilled in the art will know that variations of these embodiments are possible. For example, having different number of lines in the pop up window, different length of the lines, different font used for the lines (e.g. proportional), using different section of the GUI instead of using pop-up window, invoking the functionality with a double-cick, right click, keyboard or some other means etc.

Another feature of the preferred embodiment is keeping track of user preferences. When user makes changes, these changes are recorded in a cookie file. For example, if a particular user moves an underline from one term to another term of his/hers choice (see the example given in FIG. 11 to FIG. 13), these changes are recorded in the cookie file. Next time the user opens the same patent, this adjustment will be applied again.

User changes which can be applied to other patents, will be. These are the “reorder” button and the checkboxes. For example, if user chooses to show only one group of underlines (see example in FIG. 5), all the other patents subsequently downloaded will be shown with only that group of underlines.

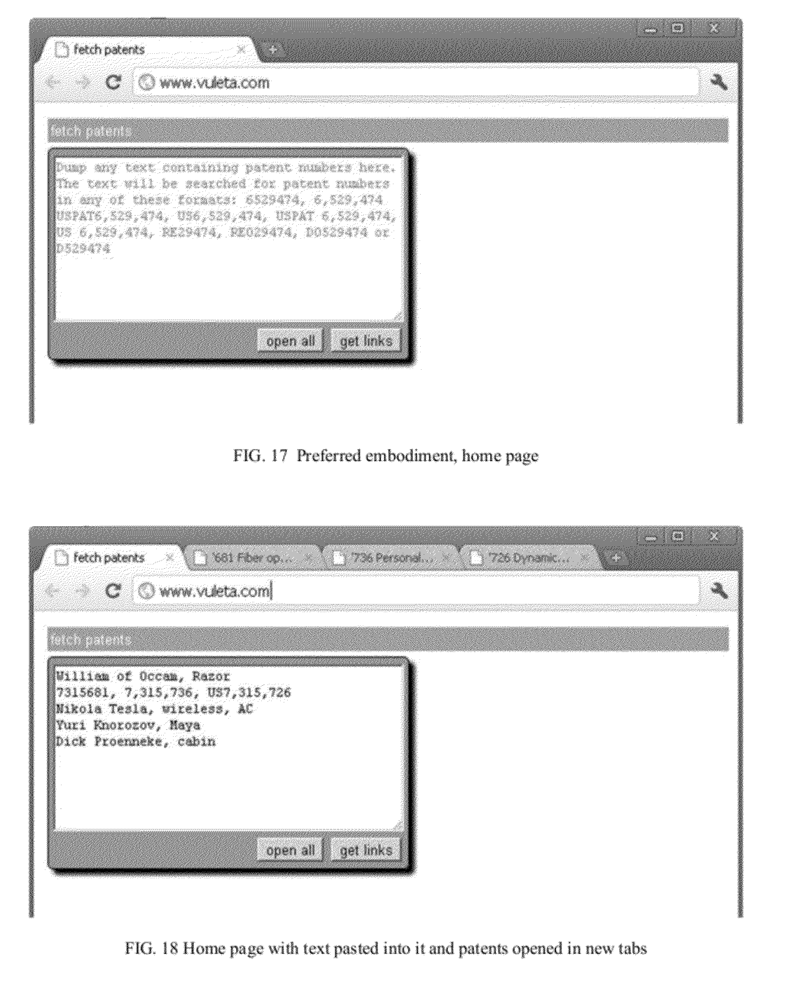

Referring to FIG. 17 now, the home page of the preferred embodiment is shown. The text in the text box explains its purpose: “Dump any text containing patent numbers here. The text will be searched for patent numbers in any of these formats: U.S. Pat. Nos. 6,529,474, 6,529,474 U.S. Pat. No. 6,529,474, U.S. Pat. No. 6,529,474, U.S. Pat. No. 6,529,474, U.S. Pat. No. 6,529,474, RE29474, RE029474, D0529474 or D529474”. This text vanishes the first time the user clicks in the text area. After the user pastes or types in some text containing patent numbers, he/she can use the button “open all” or press Enter to open all the prospective patent pages on the web site. For example, if the text contained these three patents numbers: U.S. Pat. Nos. 7,315,681, 7,315,736 and U.S. Pat. No. 7,315,726, these pages would be opened: www.vuleta.com/7315681, www.vuleta.com/7315736 and www.vuleta.com/7315726 (see FIG. 18). The new patent pages are opened as new tabs, in browsers that support this. This feature saves time and effort in various situations. For example, if the user has a number of patents listed in an Excel spreadsheet, all he/she needs to do in order to open them all, is copy and paste the content. As another example, if the user is reading a news article listing patents, he/she can copy/paste the whole article or just the paragraph listing the patents. In another example, referring to FIG. 3, user can copy references cited and open them all at once using this method.

The preferred embodiment limits the number of patents it opens at one time to 20.

This limit is imposed mostly because it may be unwieldy to handle more than 20 tabs in a browser window and as well to save bandwidth. In anther embodiment, this limit is adjusted according to the client device used. For example, if the user is using mobile phone, this limit is adjusted to be lower than if the user is using desktop PC.

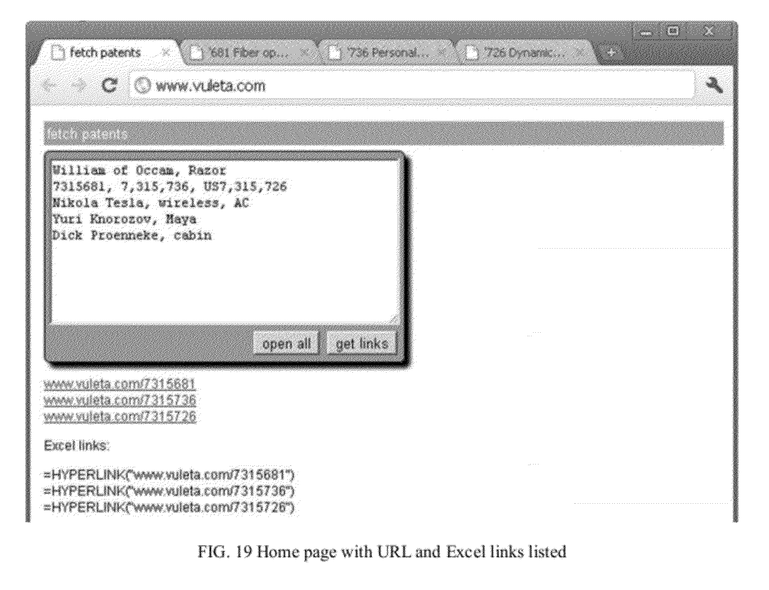

Referring to FIG. 17 again, button “get links” has a title attribute explaining its purpose: “Creates links to patents in regular URL form and in URL form ready for Excel”. FIG. 19 shows the effect of this button.

The purpose of the second list with Excel links is so it can be copied and pasted into Excel producing hyperlinks ready to be clicked on from within Excel.

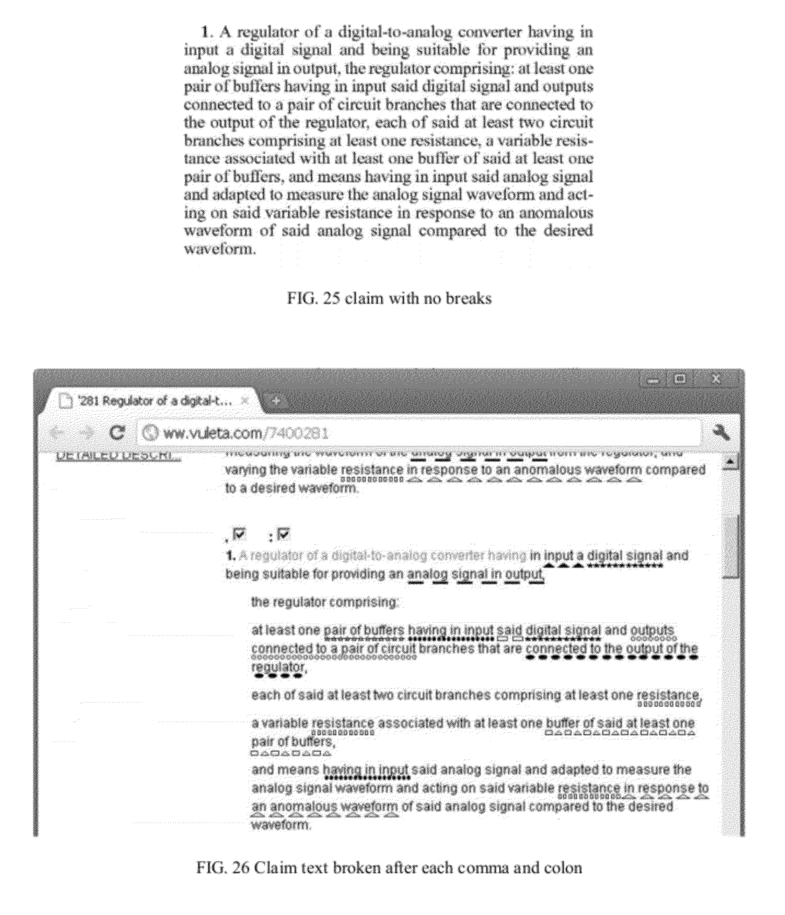

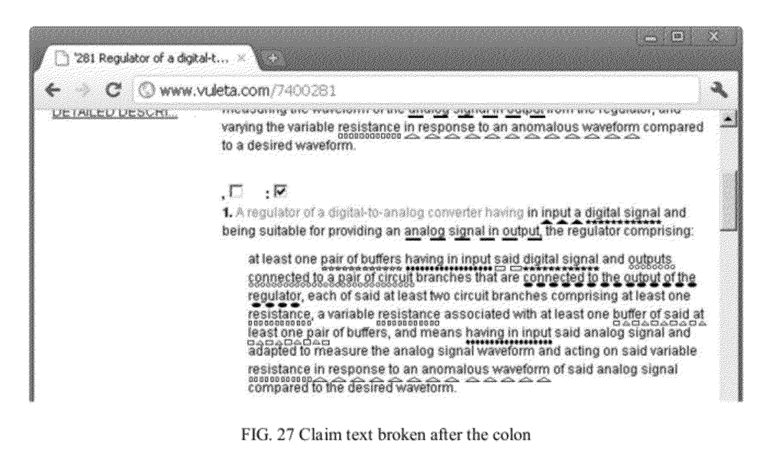

Referring to FIG. 25 now, claim 1 of U.S. Pat. No. 7,400,281 is shown as it appears in the published PDF version of the patent. The claim consists of a one monolithic paragraph. Referring now to FIG. 26, the same claim is shown in the preferred embodiment. In this example, paragraph breaks are inserted after each comma and colon in the text. In addition, there are two checkboxes above the claim, both checked. On the left of the first checkbox is a comma and on the left of the second checkbox is a colon. When a checkbox is checked, the claim text is broken into paragraphs after each corresponding character. FIG. 27 shows what happens when the comma checkbox is unchecked. The title attribute of the checkboxes explains their purpose: “Check to break into paragraphs. Uncheck to return to original formatting”.

Note that the checkboxes are checked by default. This is to spare the user from having to check them manually, given that, in the majority of cases, the added paragraph breaks are beneficial. If this turns not to be the case, the user has a convenient way of returning to the original formatting. The benefits of this feature should be obvious.

In another embodiment, claim text is broken after colon and semicolon, where needed, but no checkboxes are used to undo the action. This version may be preferable if a less cluttered user interface is desired. In yet another embodiment, the text is broken after column, semicolon and comma in this fashion.

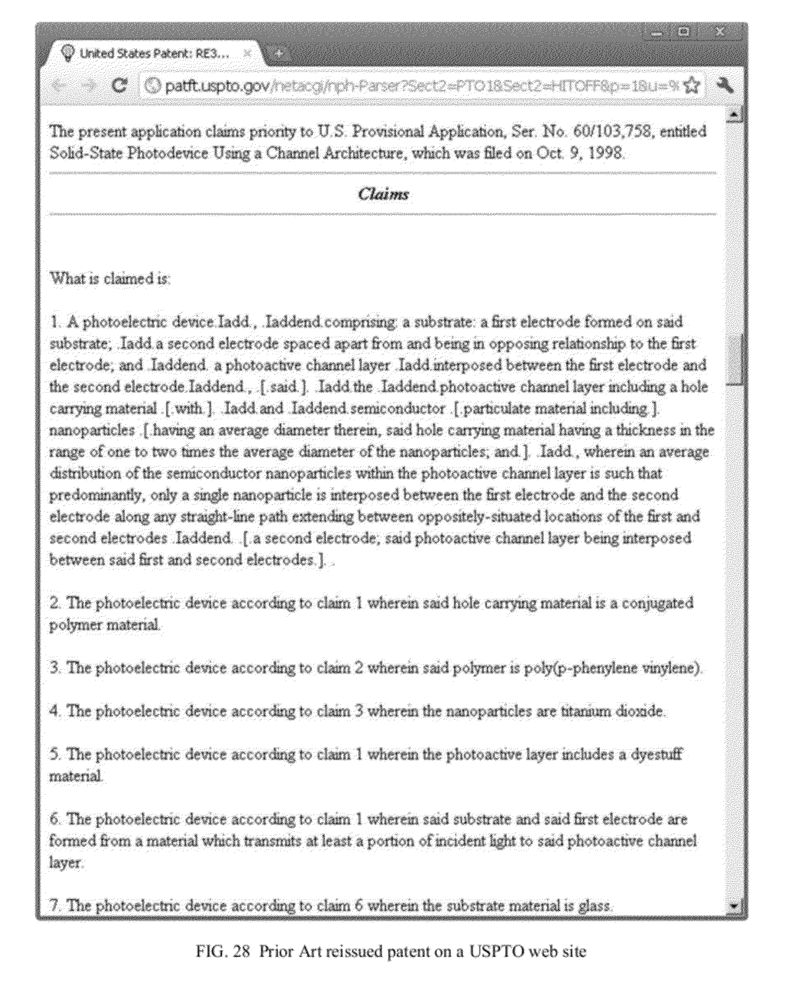

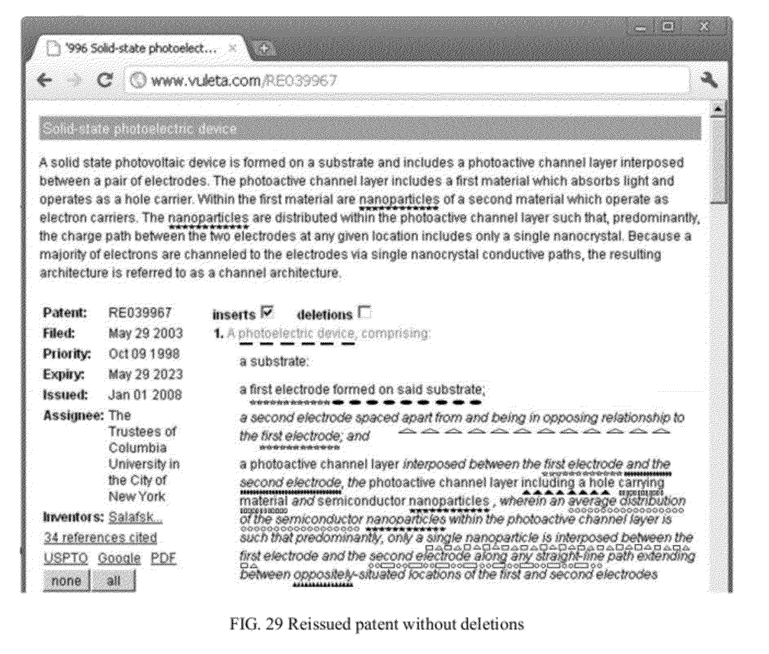

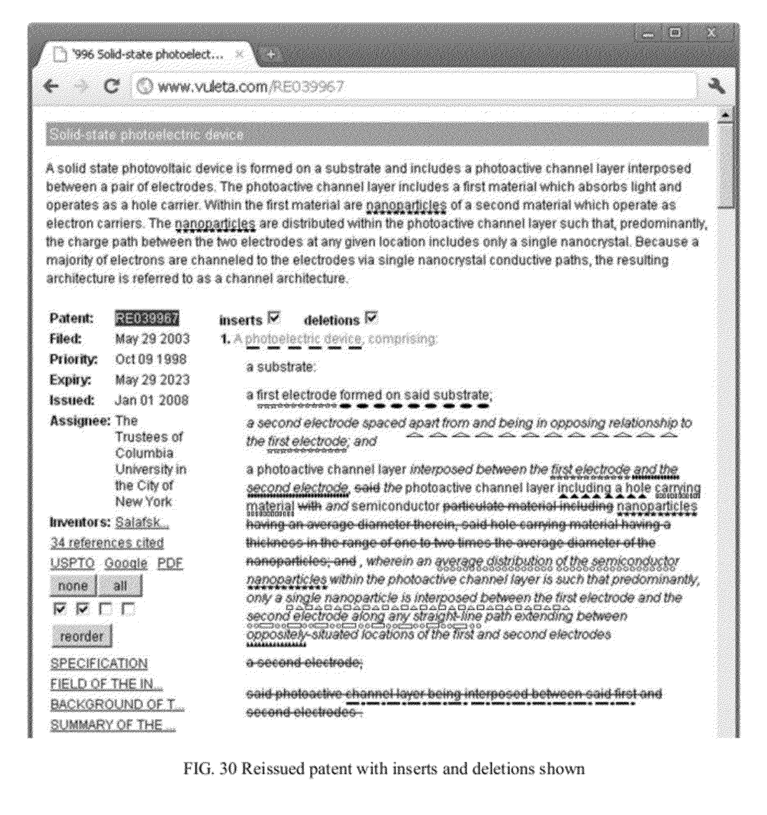

Referring to FIG. 28 now, claim 1 of RE39967 is shown on the USPTO web site. The text shown can perhaps be easily processed by a machine, but not by a human. FIG. 29 shows the same claim in the preferred embodiment. As can be seen, the deleted text is removed and the inserted text is displayed. This is the default format of the web page, when it is first delivered from the HTTP server. If the user wishes, they can view the deleted text by checking the “deletions” checkbox. FIG. 30 shows this case. The deleted text is rendered as overstriked. As can be seen, preamble in FIG. 30 is grey. In another embodiment, preamble for RE patents is of the same font as the rest of the patent, since it can not be ascertained with certainty where the preamble ends for every case since the transitional phrase may be deleted or inserted text and there may be more than one transitional phrase.

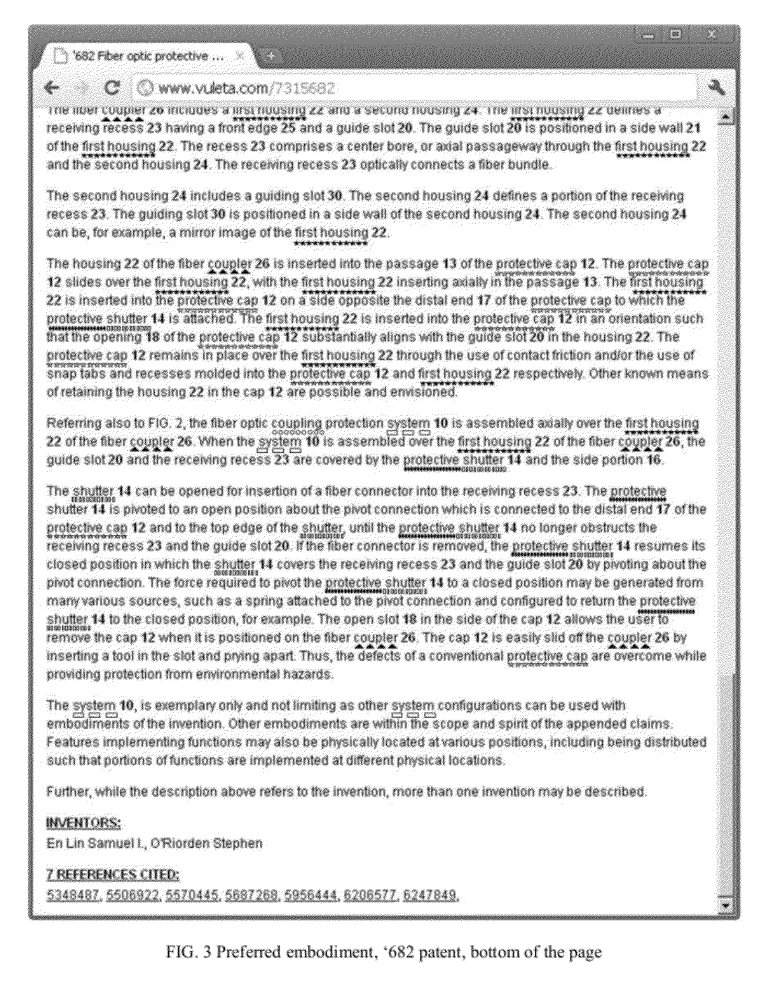

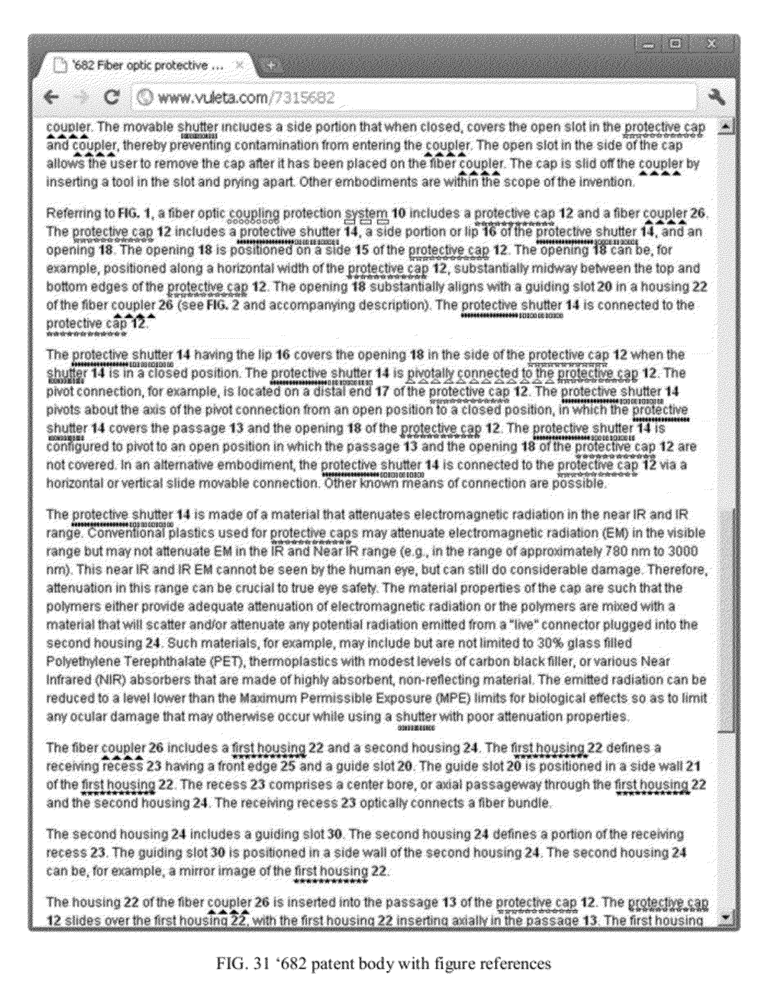

Referring to FIG. 31 now, body of the U.S. Pat. No. 7,315,682 patent is shown. As can be seen, references to figure numbers are shown in bold. They are also blue to make them easier to spot. When the user clicks on the figure reference, the figure is displayed. The figure is removed when user clicks anywhere on the page again. If user double-clicks on the figure reference, the figure is displayed rotated clockwise. In the example shown in FIG. 32, the user double-clicked on the “FIG. 2” reference. Title attribute of the figure reference explains this: “Click to show. Double-click to show rotated”.

When the figure is displayed, it is placed and resized in order not to obscure the text surrounding the figure reference clicked. If the figure reference is closer to the top of the user window, the figure is shown on the bottom. If the figure reference is to the bottom of the window, the figure is shown on the top.

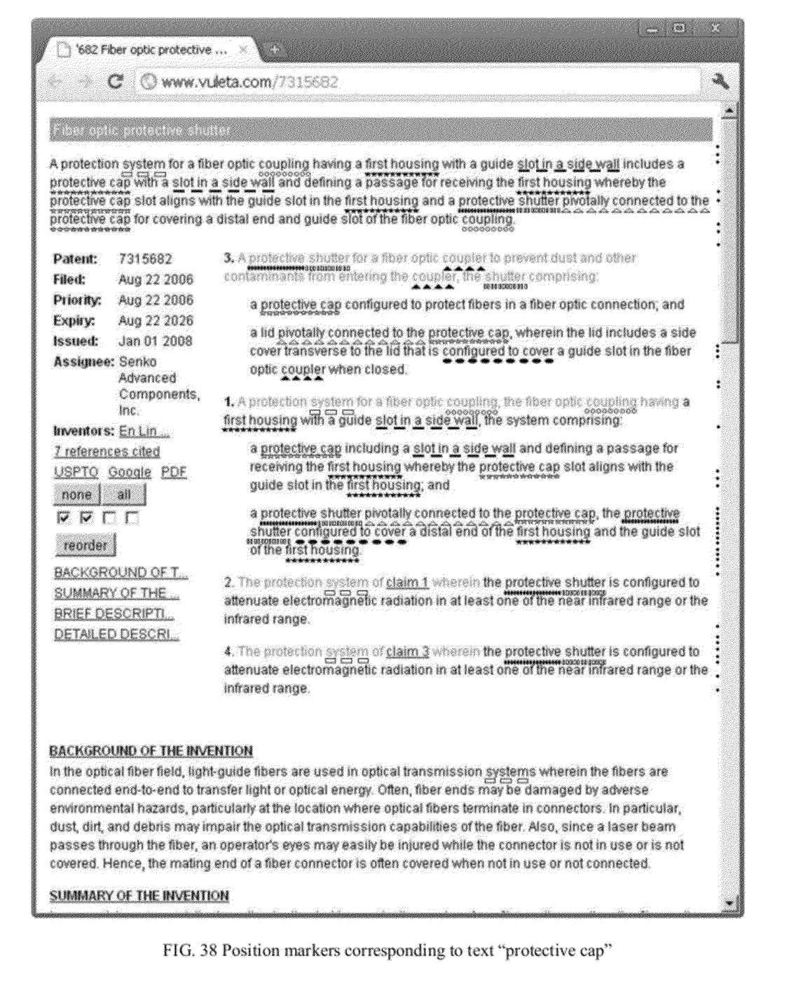

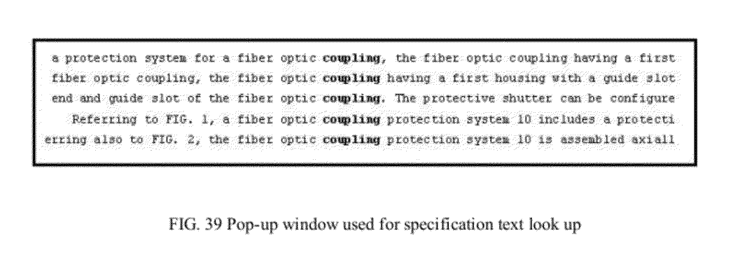

FIG. 38 shows another feature. When user clicks on any of the underlined text, occurrences of the text on the page are indicated with the position markers in the shape of dots on the right side of the screen, next to the scrolling bar. In this example, the dots mark occurrences of the text “protective cap”. For example, the first three dots correspond to the first three occurrences of “protective cap” text on in the second, third and fourth line of the abstract. The first eight dots correspond to the “protective cap” text on the visible portion of the page. The other dots correspond to the occurrences of this text on the lower part of the page which is not currently visible. When user clicks on a different underlined text, the dots are rearranged according to the positions of this new text. The color of the dots change in unison with the color of the underline line. For example, if the underline is red, the dots are red as well. In another embodiment, the shape of the markers changes in unison with the chosen underline type. If underline type is solid line, the marker is a short solid line. For dashed underlines, the marker is a short dashed line and for dotted underlines, the marker is a short dotted line. Please note that positions of the dots shown in FIG. 38 are for illustration only—they may not be precisely where they should be.

### Implementation Details

Please note that this section describes many additional inventive concepts, not necessarily limited to implementation aspects.

Following are some implementation details of the preferred embodiment.

Implementation details left out will be apparent to those skilled in the art.

The patent page shown in FIG. 1 is implemented as an HTML file (7315682.html) with CSS (Cascading Style Sheets), JavaScript code and JQuery code.

The HTML file itself (7315682.html in the example) is prepared by using USPTO provided patent data in either Green Book or Red Book format. Green Book format was used in the period 1976 to 2001 while Red Book format is used from 2001 up to now. Red Book format is described on the USPTO site at http://www.uspto.gov/web/offices/ac/ido/oeip/sgml/st32/redbook/rb2004/rb2004.html. Green Book format is described in: https://eipweb.uspto.gov/1989/PatentGrantFullTextAPS/PatentFullTextAPSDoc_GreenBo ok.pdf.

Each patent has its own html file. Creation of the html files is performed using Perl programming language. After the files are created, they are placed onto an HTTP server to facilitate web access. In one embodiment, the files are stored as compressed .gz files in order to save storage space and bandwidth required to transport them.

Following are more details explaining how the patent html files are created.

Most of the patent data in FIG. 1 is obtained directly from the USPTO patent files. These are: patent title, abstract, patent number, date of filing, date of issue, list of assignees, list of inventors, claims and patent body text.

Favisons with the three last digits of a patent are implemented in the following fashion. For example, for U.S. Pat. No. 7,315,682, the last three digits are used to create the following line:

<link rel=“shortcut icon” href=” ../../favicons/682.ico”>

This line is inserted in the <head> section of the patent html file. As can be seen, this line references 682.ico file in anther directory. This directory contains 1000 such files: 000.ico to 999.ico. In this fashon, each patent file references its own .ico file corresponding to the last three digits of the patent number. Each .ico file of size 16×16 pixels. These files were created from graphical file of bigger dimensions and were then shrank to 16×16 pixels, with higher shrinkage in horizontal direction than in vertical direction. In this fashon, three digits fit in the small space allotted for favicons while the readability is still preserved.

The priority date is the earliest date of US non-provisional applications priority dates, US provisional application dates, international dates (including the PCT priority dates) and other international dates.

Expiry date is calculated according to rules in the Manual of Patent Examining Procedure (MPEP) 2701 Patent Term [R-2].

The link “references cited”, below the Inventors, is produced by counting the number of references and concatenating the number with the “references cited” text. The example in FIG. 1 shows “7 references cited”.

The terms to be underlined are chosen in the following fashion:

These terms are chosen from the text of the independent claims of the patent. Text of all the independent claims is concatenated into one text string. This text string is then broken into tokens. Tokens correspond to words delimited by spaces, tabs, new lines, punctuation marks, double or single quotes and other special characters. All uppercase letters are converted to lower case. For example, text “To be, or not to be?” would be broken into tokens: “to”, “be”, “or”, “not”, “to” and “be”.

After the list of tokens is created, n-grams are created. N-grams are sequences of one or more tokens. 1-grams contain only 1 token, 2-grams contain two etc. In the previous example, these n-grams would be created:

1-grams: “to”, “be”, “or”, “not”, “to”, “be”

2-grams: “to be”, “be or”, “or not”, “not to”, “to be”

3-grams: “to be or”, “be or not”, “or not to”, “not to be”

4-grams: “to be or not”, “be or not to”, “or not to be”

5-grams: “to be or not to”, “be or not to be”

6-grams: “to be or not to be”

In the process of n-gram creation, list of unique n-grams and their frequencies is created. In the above example, the list would look like this: “to” with frequency of 2, “be” with frequency 2, “or” with frequency 1, “not” with frequency 1, “to be” with frequency 2 etc.

Words “N-gram” and “term” are used interchangeably in this text.

The longest n-grams created in the preferred embodiment are 7-grams.

During the process of creating n-grams, some are discarded. N-grams are compared against five lists of words:
1. list of end or start words—all n-grams that either start or end with any of these words are discarded,
2. list of 1-grams to discard,
3. list of start words—all n-grams that start with any of these words are discarded,
4. list of end words—all n-grams that end with any of these words are discarded,
5. list of any words—all n-grams that have these words at any place are discarded,

For example, some words from the list 1. are: a, about, above, across, after, afterwards. Some words from the list 2. are: method, apparatus, means, each, some, first etc. Some words from the list 3. are: determined, or, and. Some words from the list 4. are: determining, comparing, establishing, accepting, or, and. In the above example, all the n-grams would be discarded. Some words from the list 5. are: when, where, if.

Also, n-grams which originally included punctuation marks or paragraph breaks are discarded. In the above example, n-grams surrounding comma would be discarded: “to be or”, “be or”, “to be or not” etc.

Next, frequency of all surviving n-grams is recorded. In the previous example, n-grams “to”, “be” and “to be” would have frequency of 2 (assuming they were not discarded) and all the others frequency of 1.

Next, more n-grams are discarded: first, those with frequency of only 1 are discarded.

Next, n-grams which do not end with a noun or end with a word for which it is unknown if it is a noun or not. In this fashion, ngrams which end with verbs, adjectives or adverbs are discarded. In the preferred embodiment, this is achieved by forming two perl hashes: one with a list of nouns and another one with a list of non-nouns. End word of n-gram is first compared against nouns. If the result is positive, the n-gram is kept. If the word is not in this hash, it is then compared with non-nouns. Besides simple comparison with the words in the hash, three possible forms of verbs are also checked: ending with “ing”, “ed” and “s” (for second person singular form). If the result is positive, the n-gram is discarded. If none of these tests is positive, it is unknown if the word is a noun or not and the n-gram is kept.

Next, shorter n-grams which are always contained in longer n-grams are eliminated. If the shorter n-gram is part of a longer n-gram and is of the same frequency as the longer n-gram, the shorter n-gram is always contained in the longer n-gram and can be eliminated.

Then, longer n-grams which are always comprised of remaining shorter n-grams. For example: “cell lysis” is the longer n-gram. If there are surviving n-grams “cell” and “lysis”, “cell lysis” is always comprised of these two shorter n-grams. There is no need to verify that frequencies of “cell” and “lysis” are equal or greater than “cell lysis”, because this condition must be satisfied anyway (because every appearance of “cell lysis” means also one appearance of “cell” and one of “lysis”).

Next, overlapping n-grams are merged. For example, consider the case when maximum n-gram size is 2 and we have these two n-grams: “first second” and “second third”. If these two n-grams always appear together in the text (the concatenated independent claims string) as “first second third”, they are always overlapped and are merged into one n-gram “first second third”. The original n-grams “first second” and “second third” are discarded.

Finally, the last step in the creation of n-grams is eliminating surplus n-grams. In the preferred embodiment, maximum number of n-grams is 48. If there are more than 48 n-grams, the surplus is discarded, starting with those with the smallest number of words. For those with the same number of words, n-grams are additionally sorted by the number of characters, to ensure that the shortest ones are discarded. In an alternative embodiment, n-grams with the smallest frequencies are discarded instead.

The surviving n-grams are now assigned an underline type. In the preferred embodiment, the types differ by color and pattern (solid ilne, dots, dashes). Each n-gram is given a different type. There are 48 different types for the maximum of 48 n-grams. This limit is imposed on because of practical limits of producing visually distinguishable underlined patterns. The preferred embodiment has 16 solid lines of different color, 16 dashed lines of the same colors and 16 dotted lines of the same colors.

The n-grams are now divided into four groups. This division is done as evenly as possible. E.g. if there are 14 n-grams, the four n-grams will be group 1, next four group 2, next three group 3 and the last three group 4. The longest n-grams are in group 1, and the shortest in group 4. Each checkbox in FIG. 1 corresponds to one group.

The next step in the preparation of data is rendering text with the underlines previously assigned. This is done using HTML span tag. For example, HTML code for the “protective cap” in FIG. 1 looks like this:
<span class=“g1c5” ondblclick=“newNgram(this)”>protective cap</span>

where:
“<span” denotes HTML span tag start,
“g1” denotes group 1 of four possible n-gram groups,
“c5” denotes underline type for the n-gram,
ondblclick=“newNgram(this)” stipulates that when user double-clicks on this text, newNgram( ) JavaScript routine is invoked
“protective cap” is the n-gram text,
“</span> is the end of the span tag

“g1” and “c5” are CSS (Cascading Style Sheets) classes

Classes c1 to c48 define the way underline is rendered in the web browser. For example:

span.c5 {border-bottom: 2px solid #FF33FF;} /* Pink */

Classes g1 to g4 have no definition in the CSS. These classes are used to group multiple n-grams so their underlines can be turned on/off using the checkboxes. This is achieved using this JQuery code:

if (on) {

$((“span.g” + i)).removeClass(“nu”);

} else {

$((“span.g” + i)).addClass(“nu”);

}

where “on” and “i” are JavaScript variables. If “on” is true, all n-grams belonging to group “i” have “nu” class removed. If false, “nu” class is added.

The “nu” (short for “no underline”) denotes this CSS class:

span.nu {border-bottom:0px} /* no underline */

Span elements with this class added have underline removed. In the above example, this is how “protective cap” looks like with the underline removed:

<span class=“g1 c5 nu” ondblclick=“newNgram(this)”>protective cap</span>

In the preferred embodiment, there are three ways of removing an underline: clicking on the “none” button, un-checking the checkbox for the group the term belongs to, or double-clicking and removing text as illustrated in FIGS. 14, 15 and 16. They all use the same principle of adding “nu” class to n-grams.

After all n-grams are assigned c and g classes, for all n-grams, the original n-gram text in the patent is replaced with the HTML code. In the above example, all occurrences of “protective cap” are replaced with:

<span class=“g1 c5” ondblclick=“newNgram(this)”>protective cap</span>

When rendering n-grams which overlap, dashed and dotted lines are rendered on top of solid lines, when possible, in order to make them both visible. This is achieved by manipulating order of the <span> elements. As an example, refer to FIG. 36 which shows underline for n-gram “system” on top of another underline. If the longer underline was on top, the shorter one would not be visible. In another embodiment, colors are assigned to n-grams in such a way that overlapped n-grams do not have the same or similar color. In the example shown in FIG. 36—if “system” underline was of the same color as the longer underline, it would be rendered invisible. Note that some browsers, like Internet Explorer, render underlines one below the other (FIG. 37) by default. In another embodiment, the same effect can be achieved in other browsers by deliberate manipulation of the web page using, for example, JavaScript.

In the preferred embodiment, user selected underlines are always shown on top of other underlines. This is achieved by controlling the order and breaking of the <span> tags.

The process of assigning underline to a different text, illustrated in FIGS. 11, 12 and 13, is achieved using the newNgram( ) JavaScript routine. This routine retrieves the text of the n-gram that was clicked on using “this” pointer. It then creates an HTML textarea text box. The text box is positioned under the n-gram. The text in the text box is selected by using JavaScript focus( ) and select( ) routines. The text box itself is implemented as an HTML div element with two buttons: “enter” and “cancel”. The “cancel” button simply removes the textbox. The “enter” button invokes JavaScript newNgramReplaceAll( ) routine. This routine strips all n-gram <span> tags from the abstract, claims and the patent body. It then adds the n-gram <span> tag around the text entered by the user using the original underline type of the text that was double clicked on. If the user had previously reassigned underlines to other terms, this is repeated for all these terms. Finally, the routine returns <span> tags for all the n-grams, except for the ones whose underlines were reassigned.

All the n-grams and their associated underline types and groups are embedded in the patent html file in this format:
<meta name=“keywords” content=“c1:g1:pivotally connected to the protective cap;c2:g1:slot in a side wall;c3:g1:configured to cover;c4:g1:protective shutter;c5:g1:protective cap;c6:g2:first housing;c7:g2:coupling;c8:g2:coupler; c9:g2:shutter;c10:g2:system;c11:g3:guide;c1 2:g3:fiber; c13:g3: cover; c14:g3:optic;c15:g3: slot; c16:g4:lid;”></meta>

The original HTML file delivered by the HTTP server has n-gram groups g1 and g2 turned on and other groups turned off.

The HTTP server used is an Apache HTTP server. The server home page is implemented in PHP programming language and is named index.php. When user types in “www.vuleta.com” in the web browser address, PHP code in index.php responds by serving HTML page shown in FIG. 17. The HTML page is stored as compressed file in .gz format. Code in index.php checks if the browser client accepts gzip encoding (by checking for “Content-Encoding: gzip” string in the HTTP header) and serves .gz file if so. Otherwise, the file is first unzipped and then serverd as uncompressed .html file.

The home page shown in FIG. 17 is implemented as a separate html file. Its main feature is the HTML div object comprising a textarea object and two button objects. When “open all” button is clicked on, a JavaScript routine is invoked which parses the text in the textarea to find all patent numbers in various forms described above. For each patent, JavaScript “window.open( )” routine is called with the link to the patent html file and the name of the window. When “get links” button is clicked on, a different JavaScript routine is invoked which again parses the textarea text for the patent numbers and forms the links shown in FIG. 19. It then dumps the links below the text box. The routine also parses the text for non-US patent numbers, for example EP, CA, DE, DK, WO etc. Since the current implementation of the preferred embodiment does not have these patents stored on the server, it opens (or creates a link) for these patents on the European Patent Office web site Espacenet.com.

Another way of retrieving patent page is typing in the full patent URL into the web browser address. In the example shown in FIG. 1, this is “www.vuleta.com/7315682”.

As mentioned before, various other versions of the patent URL are allowed. For example, typing this URL: “www.vuleta.com/USPAT7,315,682” achieves the same effect.

In order to direct all different versions of the web browser address lines (“www.vuleta.com/USPAT7,315,682” in the example above) to the same target URL (www.vuleta.com/7315682 in the example), Apache server configuration file httpd.conf is modified by adding RewriteRule in this format:
RewriteRule/([a-zA-Z] {0,5} [\d,] {1,10}) [a-zA-Z]?[12]?(\.html|\.htm|\.php|\.asp|)$/index.php?p=$1&%{QUERY_STRING} [NC]

This rule accepts all the various versions of US patent numbers and forwards it as URL query. The URL in this form is handled by the index.php which parses the query to find the patent number, finds the patent HTML file and sends it to the user browser.

Referring now to FIG. 26, some implementation details are explained. During the creation of the patent html files, for each claim a check is made to see if the claim could benefit from being broken into more paragraphs. In the preferred embodiment, this is done by counting the number of occurrences of a comma, colon or a semicolon which are not followed by a paragraph break. If this number is found to be greater than a threshold, which in the preferred embodiment is set to 3, paragraph breaks are added after any of these punctuation marks. For each type of the punctuation mark encountered, a checkbox is added above the claim. In the example shown in FIG. 26, comma and column checkboxes are added.

Referring to FIG. 38, position markers are implemented using a vertical HTML div element on the right side of the page. Once an underlined text is clicked on, JavaScript/jQuery code is invoked. The code then fills the div element with small graphic images of white squares (for spaces) and with graphic images of dots in the color corresponding to the color of the chosen underline. The position of the dots is calculated based on the vertical positions of the underlines in the page. When different underline text is clicked on, the div is emptied and filled with new images. The same occurs when user changes size of the browser window. When the page is simply scrolled up and down, the position of the marker does not need to be changed.

### Other Embodiments

Although the preferred embodiment is a public web site, another embodiment may be implemented as an intranet web site, not accessible or with restricted access to/from the public Internet.

Another embodiment may be a client-server application where the server is a database server and the client application has a user interface with the functionality described in the preferred embodiment. Yet another embodiment can be implemented as a standalone application which includes both a database and a user interface. In another embodiment the client application may be implemented as a downloadable app. In yet another embodiment, the complete system and method, including the processing software, the data and the user interface, may be implemented as a downloadable app. In yet another embodiment, the complete system and method, including the processing software, the data and the user interface, may be implemented as a stand alone program not utilizing network or HTML. Other embodiments are possible.

Whereas the preferred embodiment comprises a collection of the prepared patent html files, in another embodiment, this collection may be implemented as a data base. In different embodiments, the database may employ a relational model, a hierarchical model, a network model, an entity-relationship model, an object-relational model, an object-oriented model or a flat-file model. Other embodiments are also possible.

In another embodiment the database may contain USPTO data in its original formatting (Red Book or Green Book). In yet another embodiment, the database may contain database records for patents, records for assignees, records for inventors, records for their mutual relationships and other records. The records may contain different fields. Other embodiments are possible.

Whereas, in the preferred embodiment, patent html files are prepared before they are placed on the HTTP server, in another embodiment, patent data may be prepared at the time when user retrieves the data, either on the server or on the client side on a machine placed in between the server and the client. Other embodiments are possible.

Whereas the preferred embodiment uses client side JavaScript to implement functionality which allows users to change the way data is displayed, another embodiment may implement this functionality on the server side. Other embodiments are possible.

Whereas, in the preferred embodiment, patent data is kept in html files, in another embodiment patent data may exist in the original USPTO formatting where each week worth of patent data is contained in one compressed or uncompressed file. In another embodiment, patent data may be kept in XML format. In another embodiment, patent data may be kept in text format. In another embodiment patent data may be encrypted. In yet another embodiment, patent text may be separate from the formatting information comprising n-grams, colors and patterns. Other embodiments are possible.

Whereas the preferred embodiment visually renders n-grams in the complete patent text, another embodiment may show only a part of the patent text. For example, patent body may be left out completely. Yet another embodiment may show only independent claims. The term “patent text” in this specification is used interchangeably to denote complete patent text or only a part of the patent text.

Whereas the preferred embodiment employs UTF-8 formatting, other embodiments may employ UTF-16, UTF-32 or other formatting. Other embodiments are possible.

In another embodiment, the individual patent html files exist in a compressed form and are decompressed at the time of retrieval. Other embodiments are possible.

In another embodiment, the patent html files may be implemented in HTML5, Ajax or a newer standard or technology. Embodiments not using HTML format at all are also possible. Other embodiments are possible.

Whereas the preferred embodiment uses HTML structural objects, like browser window, browser tab, pop-up window, text box, etc., anther embodiment may use different GUI implementation achieving similar results. For example, an embodiment in the form of a standalone application may show a frame in a window or a split window instead of using pop-up windows.

Whereas the preferred embodiment describes only issued patents, other embodiments may comprise patent applications as well.

Whereas the preferred embodiment has no application number in the patent data, other embodiments may do so. Embodiments that do show application number may do so in a form of a web link. In addition, these embodiments may use the same set of n-grams and the same association of n-grams and colors for a patent and its application. This provides users with a convenient way of comparing patents and its applications. This is especially useful, for example, to identify possible Festo issues with a patent (Festo Corp. v. Shoketsu Kinzoku Kogyo Kabushiki Co., Ltd.).

Whereas the preferred embodiment describes only US patents, other embodiments may use patent data from other countries and bodies.

Whereas the preferred embodiment describes use directed to patents, other embodiments may use other data which may or may not be related to patents. Indeed, many aspects described are applicable to non-patent text and data.

Whereas the preferred embodiment did not describe hardware used to implement it, it will be apparent to those skilled in the art that the system and the method can be implemented in many different ways: using a single server, using distributed servers, using virtual servers, using cloud, using no servers. The clients can be implemented using desktop computer, using tablets, pads, mobile phones, laptops or other forms of computing devices. The standalone application embodiment may be implemented using server computers, using desktop computer, tablets, pads, mobile phones, laptops or other forms of computing devices. Embodiments using other kinds of hardware are possible.

Whereas the preferred embodiment uses HTTP client—server network model, embodiments using different network models are possible: peer-to-peer (P2P), Content Delivery Network (CDN), Local Area Network (LAN) or no network at all. Embodiments using other network models are possible.

Whereas the preferred embodiment uses Apache web server, embodiments using other server technologies are possible.

While the preferred embodiment shows the last three digits of the patent number prefaced by an apostrophe, another embodiment may show the whole patent number instead. Another embodiment may not show the apostrophe.

As was already mentioned, other embodiments may use other means beside the underlines to mark terms. For example, one embodiment may use different colors of highlighted background. Yet another embodiment may use different patterns of background, with various symbols, images, stripes, lines and combinations thereof. Another embodiment may use more varied patterns of lines employing solid lines, dashed lines, dots, different length of dashes, combination of dots and dashes, or different thickness. Another embodiment may render the terms using patterns distinguished by different types of fonts, different sizes of fonts or different color of fonts. Another embodiment may put utilize paterns comprising frames of different color or thickness around the terms instead of underlines. Yet another embodiment, using 3D capable display, may use 3D rendering.

In case of embodiments which do not use underlines, all the functionality related to underlines may be recreated using the mode employed. For example, if an embodiment used highlighting background, it would still comprise the four checkboxes for four different groups of background types. Yet another embodiment may offer user a choice of the different means to mark terms. For example, the default patent html page may comprise a “highlight” button. When the button is pressed, the underlines are replaced with highlighted background and the button title is changed to “underline”. This embodiment may memorize the user preference (using a cookie file, for example) so it can be applied to other patents as well. Other embodiments are possible.

While, in the preferred embodiment, the functionality which chooses the terms to be underlined is implemented in Perl, other embodiments may use human input.

While the preferred embodiment chooses the terms to be underlined only from the text of independent claims, other embodiments may choose the terms from other subsets of patent data or from the whole set of patent data.

While the preferred embodiment used ico format for the favicons, another embodiment can use jpg, png or any other current or future graphical format. Person skilled in the art will know that there are various different forms of defining favicons, besides the <link rel> method described above. For example, standalone applications may not use html format nor web browsers while achieving similar effect. Another embodiment may still use web browser but use frames or other html object instead of tabs in a browser. Another embodiment may not utilize graphical format, but show the digits as regular text.

While the preferred embodiment distinguishes claim preamble from the rest of the claim, other embodiments may not do this. Yet other embodiments may distinguish the preamble using different methods from what was described above.

While the preferred embodiment lists the shorted independent claim first by default, another embodiment may list claims in their numerical order by default.

While the preferred embodiment shows independent claim numbers in bold font to distinguish them from dependent claim numbers, other embodiments may employ different ways to achieve the same result, for example color.

While the preferred embodiment shows an expired expiry date in red, other embodiments may employ different ways to mark patent as expired.

In another embodiment, the list of Assignees may list the current assignees of the patent, as reported to the USPTO or from other sources.

While the preferred embodiment shows only the first 7 characters of the names of assignee(s), other embodiments may show different number of characters. While the preferred embodiment does this only if the list of inventor names is longer than 10 characters, other embodiments may use a different number of characters. Another embodiment may show just the first inventor. Yet another embodiment may show the full list of inventors.

While the preferred embodiment uses HTML “title” attributes to explain purpose of various parts of the page, another embodiment may instead provide a help file. Yet another embodiment may provide text on the page for the same purpose. Other embodiments are possible.

While the preferred embodiment shows the information about the number of patent references cited always using the same font and font color, another embodiment may use different font or color depending on the number of references. Other embodiments are possible.

While the preferred embodiment does not show the information about the number of patents referencing the patent, other embodiments may do so. Other embodiments may also use different font or color depending on the number of references. Other embodiments are possible.

While the preferred embodiment comprises four checkboxes corresponding to four groups of underlines, other embodiments may use different number of checkboxes. Another embodiment may use one checkbox for each line type: solid, dashed, dotted. Another embodiment may use a checkbox for each underline. Yet another embodiment which uses a checkbox for each underline may list the text for an underline next to the checkbox as well. Yet another embodiment may provide a list of underlined terms allowing for choosing multiple underlines at the same time using Shift and Ctrl keys and the mouse. Yet another embodiment may provide means to drag and drop different text terms to different types of underlines to match them.

Whereas, in the preferred embodiment, independent claims are sorted by length so the shortest one is on top, another embodiment may use different criterion to choose which independent claim should be easiest to grasp and therefore deserving of top position. For example, an embodiment may, for two claims of similar length, rate the claim with more paragraph breaks as the one easier to read.

Whereas the preferred embodiment hides underlines using the “nu” class, as described above, another embodiment may instead eliminate underline by removing the <span> tag altogether. Another embodiment using highlighted background instead of underlines may use “nu” class in the form:

span.nu {background-color: white} /* no background */

Other embodiments are possible.

While in the preferred embodiment user double-clicks on an underlined text for a text box to pop up, in another embodiment this action can be invoked by a single click or a click with a right mouse button.

In another embodiment, changing the text associated with an underline type can be achieved by presenting the user with a list of underline types associated terms where the terms can be edited. Other embodiments facilitating this functionality are possible.

While the preferred embodiment, upon clicking on a link to a body heading, scrolls the web page to move the heading to where the cursor is, other embodiments may instead show the heading at the top of the page instead.

Whereas the preferred embodiment accepts various forms of US patent numbers in the home page, the implementations comprising patents from other countries or bodies may accept various additional forms of the patent numbers. Whereas the preferred embodiment opens up to 20 new patents at a time, other embodiments may impose a smaller or greater threshold or remove this limitation altogether.

Whereas the preferred embodiment creates URL links and links ready for Excel, other embodiments may produce links useful for other applications upon pressing the “get links” button.

Whereas the preferred embodiment, when checking to see if the claim could benefit from being broken into more paragraphs, counts only the number of occurrences of a comma, colon or a semicolon which are not followed by a paragraph break, another embodiment may count different characters or different patterns of characters. While the preferred embodiment uses the threshold of 3 to decide if paragraph breaks will be added, another embodiment may use a larger or smaller threshold. For example, an embodiment may count the number of (a), (b), (c) etc. occurrences not preceded by a paragraph break. Another embodiment may insert paragraph breaks only before the first occurrence of any pattern from the list (a), (b), (c) etc.

In another embodiment, if a word “and” is found immediately following the character or pattern identified as a candidate for inserting the paragraph break, the paragraph break may be inserted after the word “and”. This is to facilitate proper breaking in this form:

“An invention comprising:

widget 1,

widget 2, and

widget 3”

Besides the (a), (b), (c) patterns, another embodiment may in addition process (i), (ii), (iii) patterns as well. Other embodiments processing other patterns are also possible. In addition, another embodiment may indent text to the right after the colon character.

Whereas the preferred embodiment is implemented using HTML, CSS, JavaScript, JQuery, Perl and PHP, embodiments implemented with other programming languages and standards are possible.

Whereas the longest n-grams in the preferred embodiment are 7-grams, other embodiments may use a different limitation. Yet another embodiment may not limit the longest n-gram size at all.

Whereas the preferred embodiment chooses n-grams from within the text of independent claims only, another embodiment may choose n-grams from all the claims. Yet another embodiment may choose n-grams from all the claims and the body of the patent. Yet another embodiment may choose n-grams from all the claims and the body of the patent excluding the Background section. Other embodiments are possible.

In another embodiment, choosing n-grams may be performed in a different way. For example, besides the four lists of words (1. to 5.) mentioned above, more lists of words may be used. There can be a list of words of more significance which, for example, contains words “first”, “second”, “third” etc. N-grams starting with this word may be given higher priority so they would less likely be discarded.

In another embodiment, terms prefaced with “a” when they are introduced the first time and “the” or “said” in subsequent times, may be given higher priority so they would be less likely eliminated.

In another embodiment, different lists of words may be used for different classes of patents. For example, if a patent is classified as 327/52 under U.S. classification (“differential amplifier” class), n-gram “differential amplifier” would be given higher priority.

In another embodiment, more lists of words which are chosen from the patent context may be used. For example, if word “transmitter” is used, the word “receiver” may be given higher priority to ensure it would have better chances of surviving the process of n-gram elimination.

In another embodiment, when the user manually chooses a term to be underlined, this information may be transmitted to the server so the patent html file can be changed accordingly.

In another embodiment, n-grams comprising words which are less frequently found in the general dictionary or in a specialized dictionary may be given higher priority during the process of choosing n-grams. For example, U.S. Pat. No. 6,226,262, claim 1, uses words “system” and “calendar”. The word “calendar” is of smaller frequency and therefore probably has more importance for a user trying to understand the claim. Therefore, the word “calendar” and the n-grams comprising it may be given higher priority. Embodiments using different forms of the “term frequency-inverse document frequency” method are possible. Embodiments employing other methods of text mining and information retrieval are possible.

In another embodiment, n-grams with frequency of 1 may not be discarded. This would particularly be useful for the above mentioned cases where n-grams of higher priority are identified.

In the preferred embodiment, n-grams which do not end with a noun or an unknown word are discarded. Another embodiment may not employ this. Other embodiments are possible.

In the preferred embodiment, longer n-grams which are always comprised of other, shorter, n-grams and shorter n-grams which are always contained in longer n-grams, are discarded. Another embodiment may not employ this. Other embodiments are possible.

When assigning an underline type to an n-gram, another embodiment may identify synonyms so they are assigned the same type. For example, both “a/d converter” and “ADC” would be assigned the same type.

Another embodiment may identify n-grams using different forms as the same n-gram. For example, if a claim contains “pair of signals” and “signal pair”, these can be counted as the same n-gram. In one embodiment, these n-grams may be identified as those that differ only in specific, less important, words and/or specific forms of words, ignoring the order of words. In the example given, the difference between the two n-grams is the word “of” and letter “s”, for the plural form. As well, the plural form of a noun may be treated as the same n-gram (e.g. “signal” and “signals”). Accordingly, these forms would be assigned the same underline type.

Whereas the preferred embodiment limits the number of n-grams to 48, another embodiment may use a different limit or may not use a limit at all. Another embodiment may adjust the number of n-grams per patent depending on the number and size of the claims. For example, if the patent has only 2 short claims, 48 n-grams may be too much because there would be too many terms underlined and the ensuing visual clutter would be more distracting than helpful. In the opposite example, if the patent has 50 long independent claims, it may be beneficial to increase the number of n-grams to avoid having long sections of text with no terms underlined.

Whereas, in the preferred embodiment, user has to click on a figure number in order to display the figure, another embodiment may display the figure when cursor hovers over the figure number instead. The same embodiment may display the figure rotated clockwise when the user clicks on the figure. Yet another embodiment may display the figure in a smaller format on the margin of the text, next to the line where it is mentioned. In this embodiment, the figure may be displayed in a larger format upon clicking on it and it may be displayed in a larger format rotated clockwise upon double-clicking on it.

Whereas, in the preferred embodiment, the position markers are implemented using a vertical HTML div element, another embodimiment may use non-browser user interface implementing similar functionality.

Other embodiments and uses will be apparent to those skilled in the art in consideration of the specification and practice of the embodiments disclosed herein. The specification and examples should be considered exemplary only. The scope of the invention is only limited by the claims.

What is claimed is:

1. A computer-implemented method for preparing patent text for visual display comprising:
choosing a list of unique n-grams from a portion of the patent text;
assigning each unique n-gram a pattern or a color or a combination of pattern and color.

2. The method of claim 1, where occurances of n-grams in the patent text are rendered in a visual display according to the pattern or the color or the combination of pattern and color.

3. The method of claim 1, where the portion of the patent text consists of independent claims of the patent.

4. The method of claim 1, where the portion of the patent text consists of all claims of the patent.

5. The method of claim 2, where independent claims are displayed above dependent claims, wherein the independent claims are ordered according to their length and the dependent claims are ordered according to their numerical order.

6. The method of claim 5, where all the claims can be reordered according to their numerical order.

7. The method of claim 2, where each unique n-gram is assigned to a group.

8. The method of claim 7, where rendering occurances of n-grams in a visual display according to the pattern or the color or the combination of pattern and color can be turned on or off per group.

9. The method of claim 1, where choosing the list of unique n-grams comprises one or more of these steps:
discarding unique n-grams with frequency of 1,
discarding unique n-grams which end with a non-noun,
discarding shorter unique n-grams which are always contained in longer unique n-grams,
discarding longer unique n-grams which are always comprised of shorter unique n-grams,
merging overlapping unique n-grams,
prioritizing unique n-grams for discarding according to term frequency-inverse document frequency,
prioritizing unique n-grams so those starting with words “first” or “second” are less likely to be discarded.

10. A computer-implemented method for visual display of a patent text comprising:
receiving the patent text;
receiving n-grams with associated pattern or color or both;
visually rendering occurances of the n-grams in the patent text according to the pattern or the color or both.

11. The computer-implemented method of claim 10 wherein the n-grams are chosen only from independent claims text.

12. The computer-implemented method of claim 10 wherein the n-grams are chosen only from claims text.

13. The method of claim 10, where shortest independent claim is displayed above other claims.

14. The method of claim 13, where means are provided for reordering the claims according to their numerical order.

15. The method of claim 10, where the n-grams are grouped in one or more groups wherein visually rendering occurances of the n-grams according to the pattern or the color or both can be turned on or off per group.

16. The method of claim 10, where the n-grams do not comprise one or more of:
n-grams with frequency of 1,
n-grams which end with a non-noun,
shorter n-grams which are always contained in longer n-grams,
longer n-grams which are always comprised of shorter n-grams.

17. A user interface for displaying patents comprising an object for showing only a portion of a patent number.

18. The user interface of claim 17, wherein the object is a web page favicon.

19. The user interface of claim 17, wherein the portion of the patent number consists of three last digits of the patent number.
